(19) United States
(12) Patent Application Publication
(10) Pub. No.: US 2024/0067803 A1
(43) Pub. Date: Feb. 29, 2024

(54) SUGAR-BASED COMPOSITE MATERIALS AS ALTERNATIVES TO PLASTICS

(71) Applicant: Boise State University, Boise, ID (US)

(72) Inventors: Scott Phillips, Boise, ID (US); Terra Miller-Cassman, Boise, ID (US)

(21) Appl. No.: 18/452,212

(22) Filed: Aug. 18, 2023

Related U.S. Application Data
(60) Provisional application No. 63/371,904, filed on Aug. 19, 2022.

(51) Int. Cl. C08L 1/02; C08J 11/08

(52) U.S. Cl. CPC C08L 1/02; C08J 11/08; C08J 2301/02; C08J 2401/02; C08J 2493/02

(57) ABSTRACT

Disclosed herein are sugar-based composites that are a recyclable and environmentally friendly replacement for plastics. The sugar-based composites are a renewable, recyclable, degradable, energy-efficient, and lightweight replacement of plastics in short term use applications. The sugar-based composites comprise small molecule sugar compounds. Methods of preparing and methods of recycling the sugar-based composites are also disclosed.

### CROSS-REFERENCE TO RELATED APPLICATIONS

This application claims priority under 35 U.S.C. § 119 to provisional application Ser. No. 63/371,904, filed Aug. 19, 2022 herein incorporated by reference in its entirety.

### TECHNICAL FIELD

The present disclosure relates to sugar-based composites that are suitable as a recyclable and environmentally friendly replacement for plastics. The sugar composites described herein are particularly conducive as a renewable, recyclable, degradable, energy-efficient, lightweight, and inexpensive replacement of plastics in short term use applications.

### BACKGROUND

Traditionally, plastics have been designed to achieve high performance and maximum functional lifetimes, yet many plastics are employed in single-use or short-term-use applications. Despite this mismatch between the material's properties and the application, plastics represent the only viable material for mass-producing inexpensive, lightweight, short-term-use products. Moreover, the resilience and ubiquitous use of plastics has caused them to become a persistent pollutant, and much of this pollution is associated with plastics that are used only once or a few times and then discarded.

Thus, there exists a need in the art for materials with functional lifetimes that are commensurate with short-term-use applications. There exists a need for materials that are non-toxic, naturally abundant, and inexpensive as an alternative that can meet the utility design thresholds of many single or short-term use commodity products that could be efficiently and repeatedly recycled into new products, and that could degrade rapidly in the environment into non-toxic components.

### BRIEF SUMMARY OF THE INVENTION

The present disclosure provides a sugar-based composite material comprising a melt-processed small molecule sugar comprising a sugar alcohol and from about 5 wt-% to about 60 wt-% of an additive. In an embodiment, the small molecule sugar comprises isomalt, vitrified isomalt, sorbitol, erythritol, mannitol, maltitol, xylitol, sucrose, ribose, xylose, galactose, mannose, sorbose, maltose, lactose, lactulose, trehalose, sucrose octaacetate, or mixtures thereof. In an embodiment, the additive comprises wood flour, sawdust, calcium carbonate, casein, cellulose, cellulose derivatives, hemp, grass, salt, sodium chloride, wheat gluten, white flour, kaolin, starch, crushed glass, agricultural waste, chitosan, chitin, algae, algae derivatives, fabrics, fibers, plant fibers, natural carboxylic acids , pectin, or mixtures thereof. In an embodiment, the sugar-based composite material further comprises a dye, a pigment, a fragrance, a solvent, a carrier, a thickener, a solidifying agent, a clarifying agent, a plasticizer, an antioxidant, an antimicrobial, a processing aid, a decoration, or mixtures thereof. In an embodiment, the sugar-based composite material has a density of from about 1.2 g/cm³ to about 1.5 g/cm³, a flexural strength of from about 14 MPa to about 30 MPa, a flexural modulus of from about 1.3 GPa to about 2.5 GPa, a compressive strength of from about 50 to about 150 MPa, and a hardness of from about 84 HD to about 88 HD. In an embodiment, the sugar-based composite material has a dissolution rate of at least about two to about twenty times slower than the small molecule sugar, increased resistance to humidity and temperature fluctuations as compared to the small molecule sugar, a hardness measurement that is reduced by less than about 20% when exposed for 1 hour at a relative humidity above 50%, and wherein the mass of the sugar-based composite material increases by less than about 10% when exposed for 1 hour at a relative humidity above 50%.

In an embodiment, at least a portion of the sugar-based composite material further comprises at least one coating. In an embodiment, the sugar-based composite material comprises a primer between at least a portion of the sugar-based composition and at least a portion of the coating. In an embodiment, the coating is hydrophobic, non-toxic, food safe, and/or is biodegradable. In an embodiment, the coating comprises cellulose acetate, zein, stearic acid, monoglycerides, a plastic, a polymer, a natural resin, a plasticizer, oils, fats, waxes, metals, dyes, decorations, composite materials, or mixtures thereof. In an embodiment, the coating decreases a dissolution rate of the sugar-based composite material by at least about 2-fold, wherein a change in mass of the sugar-based composite material is negligible when exposed for 1 hour to relative humidity values up to about 50% at 20° C. In an embodiment, a change in hardness values of the sugar-based composite material comprising a coating is negligible when exposed for 1 hour to relative humidity values up to about 50% at 20° C.

Disclosed herein is a method of making a sugar-based composite material comprising combining a melt-processed small molecule sugar comprising a sugar alcohol with from about 5 wt-% to about 60 wt-% of an additive to form a sugar-based composite material, wherein the small molecule sugar is heated and liquified prior to mixing with the additive, and wherein the sugar-based composite material is a solid at room temperature. In an embodiment, the small molecule sugar comprises isomalt, sorbitol, erythritol, mannitol, maltitol, xylitol, sucrose, ribose, xylose, galactose, mannose, sorbose, maltose, lactose, lactulose, trehalose, sucrose octaacetate, or mixtures thereof and the additive comprises cellulose, wood flour, sawdust, calcium carbonate, casein, cellulose, cellulose derivatives, hemp, grass, salt, sodium chloride, wheat gluten, white flour, kaolin, starch, crushed glass, agricultural waste, chitosan, chitin, algae, algae derivatives, fabrics, fibers, plant fibers, natural carboxylic acids, pectin, or mixtures thereof. In an embodiment, the sugar and the additive are combined by mixing, stirring, shaking, and/or vibrating. In an embodiment, the sugar-based composite material is thereafter formed into a product by cooling until solid, extrusion, molding, 3D printing, casting, thermoforming, compression molding, vacuum forming, pelletizing, injection molding, laser cutting, hand sawing, power sawing, drilling, and/or heat pressing, by plane, chisel, mallet, hammer, and/or sander. In an embodiment, the method comprises combining the sugar-based composite material with a dye, a pigment, a fragrance, a solvent, a carrier, a thickener, a solidifying agent, a clarifying agent, a plasticizer, an antioxidant, an antimicrobial, a processing aid, a decoration, or mixtures thereof.

In an embodiment, the method further comprises applying at least one coating to at least a portion of the sugar-based composite. In an embodiment, method comprises applying a primer to the sugar-based composite prior to the coating. In an embodiment, the method comprises curing the coating and/or primer. In an embodiment, the coating and/or the primer is applied by painting, dipping, spraying, vapor depositing, printing, lithographic techniques, and/or wrapping and wherein the curing is by a photochemical reaction, a polymerization reaction, evaporation, cooling, and/or heating.

Disclosed herein is a method of recycling a sugar-based composite material comprising breaking a sugar-based composite material comprising a melt-processed small molecule sugar comprising a sugar alcohol and about 5 wt-% to about 60 wt-% of an additive into at least two smaller pieces, heating the pieces at a temperature above the glass transition or melt temperature of the small molecule sugar, and extruding to form pellets or shaping into recycled sugar-based composite material products. In an embodiment, the pellets are formed into recycled sugar-based composite materials by extrusion, molding, 3D printing, casting, thermoforming, compression molding, vacuum forming, and/or heat pressing. In an embodiment, the recycled sugar-based composite material is shaped by extrusion, molding, 3D printing, casting, thermoforming, compression molding, vacuum forming, and/or heat pressing. In an embodiment, the small molecule sugar comprises isomalt, sorbitol, erythritol, mannitol, maltitol, xylitol, sucrose, ribose, xylose, galactose, mannose, sorbose, maltose, lactose, lactulose, trehalose, sucrose octaacetate, or mixtures thereof and the additive comprises wood flour, sawdust, calcium carbonate, casein, cellulose, cellulose derivatives, hemp, grass, salt, sodium chloride, wheat gluten, white flour, kaolin, starch, crushed glass, agricultural waste, chitosan, chitin, algae, algae derivatives, fabrics, fibers, plant fibers, natural carboxylic acids, pectin, or mixtures thereof. In an embodiment, the sugar-based composite material further comprises a dye, a pigment, a fragrance, a solvent, a carrier, a thickener, a solidifying agent, a clarifying agent, a plasticizer, an antioxidant, an antimicrobial, a processing aid, a decoration, or mixtures thereof. In an embodiment, at least a portion of the sugar-based composite material further comprises a coating comprising cellulose acetate, shellac, a plasticizer, plastic, polymer, natural resins, waxes, oils, fats, metals, dyes, decorations, composite materials, or mixtures thereof.

Disclosed herein is a method of recycling a sugar-based composite comprising dissolving a sugar-based composite material as disclosed herein in an aqueous environment to separate the sugar-based composite material from the coating, and recovering the sugar-based composite material, wherein the recovery of the sugar-based composite material is greater than about 50%, greater than about 60%, greater than about 70%, or greater than about 80%.

### BRIEF DESCRIPTION OF THE FIGURES

The patent or application file contains at least one drawing or photograph executed in color. Copies of this patent or patent application publication with color drawing(s) will be provided by the Office upon request and payment of the necessary fee.

The following drawings form part of the specification and are included to further demonstrate certain embodiments. In some instances, embodiments can be best understood by referring to the accompanying figures in combination with the detailed description presented herein. The description and accompanying figures may highlight a certain specific example, or a certain embodiment. However, one skilled in the art will understand that portions of the example or embodiment may be used in combination with other examples or embodiments.

FIG. 1 is a schematic of the processing, production, degradation, and recycling lifecycle of an exemplary sugar composite with small molecule sugar isomalt.

FIG. 2 depicts an exemplary processing of isomalt into a composite material comprising an additive, which is then processed into pellets which are processed into useful products.

FIG. 3 is a plot of flexural strength of sugar composites with increasing concentrations of microcrystalline cellulose.

FIG. 4 is a plot of flexural strength of sugar composites with increasing concentrations of wood flour.

FIG. 5 is a DSC thermogram of sugar composites with and without additives.

FIG. 6 shows FESEM images of a cross-section of the fracture surface for sugar-based composites comprising: a) pure amorphous isomalt with 1 mm scale; b) pure amorphous isomalt with 100 μm scale; c) isomalt with 30 wt-% microcrystalline cellulose with 1 mm scale; d) isomalt with 30 wt-% microcrystalline cellulose with 40 μm scale; e) isomalt with 25 wt-% wood flour with 500 μm scale; and g) isomalt with 25 wt-% wood flour with 100 μm scale.

FIG. 7 shows a plot of compressive strength versus density for sugar-based composite materials (orange) in comparison with common plastics (blue) and ceramics and stones (green).

FIG. 8 is a plot of compressive strength versus flexural strength for sugar-based composite materials (orange) in comparison with common plastics (blue) and ceramics and stones (green).

FIG. 9 depicts Shore D hardness versus flexural strength for sugar-based composite materials (orange) in comparison with common plastics (blue).

FIG. 10 shows FESEM various images of an isomalt sugar composite with 30 wt-% microcrystalline cellulose coated with a shellac base and then cellulose acetate.

FIG. 11 is a plot of Shore A hardness and with exposure to incremental increases in relative humidity for uncoated and coated sugar composites.

FIG. 12 is a plot of weight with exposure to incremental increases in relative humidity for the uncoated and coated sugar composites.

FIG. 13 contains photographs of sugar-based composite materials coated with a shellac base and then cellulose acetate immediately after (A) and 8 hours after (B) submersion in water.

FIG. 14 is a plot of flexural strength of sugar composites before and after the amorphous isomalt material was recovered after dissolved and separated from a coating.

FIG. 15 shows ¹H NMR spectra of sugar composite before and after dissolution and recovery.

FIG. 16 contains images of object demonstrations formed from injection molding of a sugar composite comprising amorphous isomalt and 30 wt-% microcrystalline cellulose.

FIG. 17 is a plot of flexural strength of a sugar composite before and after mechanical recycling.

FIG. 18 shows a DSC thermogram taken of pure amorphous isomalt subjected to seven heat ramps.

FIG. 19 shows NMR spectra of crystalline isomalt and amorphous isomalt that has been processed seven times.

FIG. 20 shows DSC thermograms of isomalt, microcrystalline cellulose, and wood flour.

FIG. 21 is a plot of flexural strength for sugar composites with various additives.

FIG. 22 displays a DSC thermogram comparing the thermal transitions of pure crystalline erythritol and erythritol combined with 32 wt-% microcrystalline cellulose.

FIG. 23 is a plot of flexural strength of erythritol-based materials with increasing concentrations of microcrystalline cellulose.

FIG. 24 shows the changes in Shore A hardness with exposure to incremental increases in relative humidity for uncoated specimens of erythritol+32 wt-% microcrystalline cellulose and compared to isomalt composite materials, both with and without a shellac and cellulose acetate coating.

FIG. 25 shows the changes in mass with exposure to incremental increases in relative humidity for uncoated specimens of erythritol+32 wt-% microcrystalline cellulose and compared to isomalt composite materials with and without a shellac and cellulose acetate coating.

FIG. 26 shows photographs of: A) an isomalt sample coated with a zein solution product Cozeen 303N, and B) an isomalt sample coated with a zein solution product MasterCoat Glaze ZZ-F.

FIG. 27A is a photograph of an isomalt sheet with a single layer of glycerol monostearate powder.

FIG. 27B is a photograph of an isomalt sheet with a glycerol monostearate coating.

FIG. 28A shows a portion of a coated isomalt sheet submerged in deionized water after 1 second.

FIG. 28B shows a portion of a coated isomalt sheet submerged in deionized water after two hours.

FIG. 29 is a photograph of isomalt composites with 4 wt-% pectin.

FIG. 30 is a photograph of sorbitol composites with 4 wt-% pectin.

FIG. 31 a photograph of isomalt composites with 1 wt-% stearic acid.

FIG. 32A a photograph of a sorbitol and citric acid amorphous solid after cast into a mold and cooled.

FIG. 32B is a photograph of a sorbitol and citric acid amorphous solid twisted into a curled shape

Reference to various embodiments does not limit the scope of the invention. Figures represented herein are not limitations to the various embodiments according to the invention and are presented for exemplary illustration of the invention.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

The present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

Numeric ranges recited within the specification are inclusive of the numbers within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numerical values within that range, for example, 1, 2, 3, 4, 5, and 6, and decimals and fractions, for example, 1.2, 3.8, 1½, and 4¾ This applies regardless of the breadth of the range.

As used herein, the term “exemplary” refers to an example, an instance, or an illustration, and does not indicate a most preferred embodiment unless otherwise stated.

The term “about,” as used herein, refers to variations in size, distance or any other types of measurements that can be resulted from inherent heterogeneous nature of the measured objects and imprecise nature of the measurements itself, including, but not limited to, concentration, mass, volume, length, weight, density, flexural modulus, flexural strength, hardness, melting point, purity, strength, and thickness. The term “about” also encompasses variation in the numerical quantity that can occur, for example, through typical measuring or handling procedures in the real world; through inadvertent error in these procedures; through differences in the manufacture, source, or purity of the ingredients used to make the device or carry out the methods, and the like. Whether or not modified by the term “about”, the claims include equivalents to the quantities.

The term “substantially” refers to a great or significant extent. “Substantially” can thus refer to a plurality, majority, and/or a supermajority of said quantifiable variable, given proper context.

As used herein, matter in the form of a “solid” has, and retains, a distinct shape and volume.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

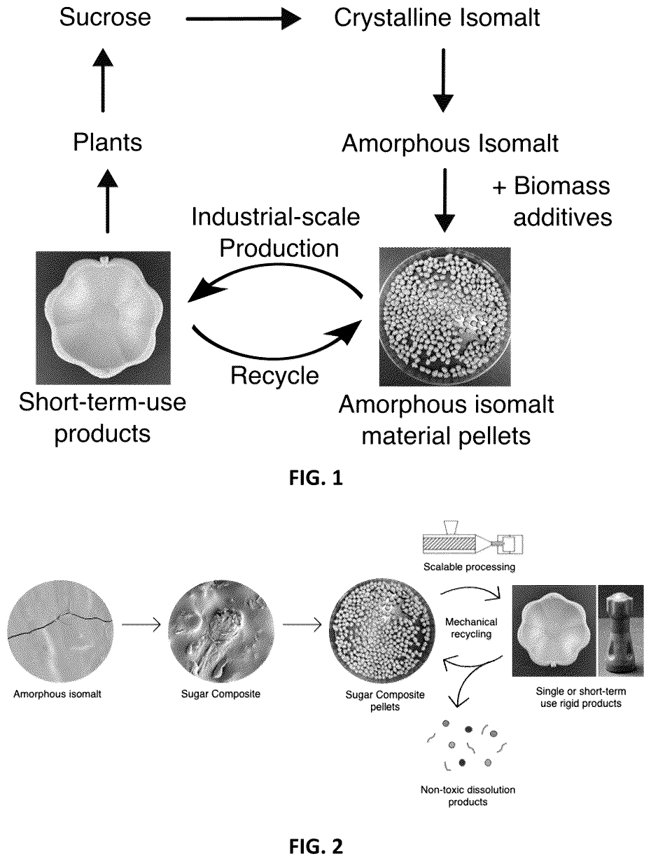

The disclosure herein is related to sugar composite materials comprising a small molecule sugar and one or more additives. An example of the processing, production, degradation, and recycling lifecycle of an exemplary sugar composite with small molecule sugar isomalt is shown in FIG. 1. Isomalt is generated from sucrose, which is naturally abundant in plants. Plant-based additives strengthen the resulting sugar composite and allow for the turning of the physical and mechanical properties of said composite. The sugar composite materials can be processed into pellets and injection molded like plastics, yet can be repetitively reground and re-processed without significant degradation or loss of mechanical properties. Another example of processing, recycling, and environmental deterioration flow is shown in FIG. 2. FIG. 2 shows an example of processing isomalt into a composite material comprising an additive, which is then processed into pellets which are processed into useful products. The products can then be recycled or dissolved into non-toxic components.

### Sugar-Based Composite Materials

Described herein is a sugar-based composite material based on small molecule sugars. In an embodiment, the small molecule sugar comprises a sugar alcohol.

In certain embodiments, melt-processed small molecule sugars are combined with at least one additive, wherein the additive is used to tune the mechanical and/or physical properties of the resultant sugar-based composite material. As used herein, “melt-processed” is meant to describe a crystalline sugar that has been exposed to heat above its melt temperature and mixed with additives to form a composite material.

In certain embodiments, the small molecule sugar is vitrified to form a stable glass. As used herein “vitrified” and “glassy” and “amorphous” are used interchangeably and meant to describe a sugar-based material that has been made glassy through exposure to heat. In certain embodiments, vitrified small molecule sugars are combined with at least one additive, wherein the additive is used to tune the mechanical and/or physical properties of the resultant sugar composite material.

In an embodiment, the sugar composite comprises a vitrified small molecule sugar and an additive. As used herein “sugar” refers to saccharides, a class of small molecule carbohydrates, including monosaccharides, disaccharides, and sugar alcohols. Sugars generally carry the hydroxyl functional group, which readily reacts with other hydroxyl and carbonyl groups to form intra- and intermolecular hydrogen bonds. Counter to the covalent bonds of polymers, the hydrogen bonds that adhere sugars are more readily dissociated in aqueous or biological conditions, which is beneficial for rapid dissociation or degradation in the environment. Further, sugars are relatively inexpensive and can be produced with high purity in large quantities.

In an embodiment, the sugar comprises a non-reducing sugar. In an embodiment, the sugar does not decompose at high temperatures. In an embodiment, the sugar has low relative hygroscopicity.

In an embodiment, the sugar comprises a sugar alcohol. In an embodiment, the sugar alcohol comprises isomalt, sorbitol, erythritol, mannitol, maltitol, xylitol, sucrose, ribose, xylose, galactose, mannose, sorbose, maltose, lactose, lactulose, trehalose, sucrose octaacetate, or mixtures thereof. In an embodiment, the sugar comprises isomalt. In an embodiment, the sugar comprises amorphous isomalt. In an embodiment, the sugar comprises erythritol.

In an embodiment, the additive is derived from plants, or plant-based. In an embodiment, the additive comprises hydroxyl groups that are available for hydrogen bonding with the sugar.

In an embodiment, the additive is biodegradable. In an embodiment, the additive is non-toxic. In an embodiment, the additive is biodegradable and non-toxic. In an embodiment, the additive does not decompose thermally until heated above the glass transition temperature of the sugar.

In an embodiment, the additive comprises wood flour, sawdust, calcium carbonate, casein, cellulose, cellulose derivatives, hemp, grass, salt, sodium chloride, wheat gluten, white flour, kaolin, starch, crushed glass, agricultural waste, chitosan, chitin, algae, algae derivatives, fabrics, fibers, plant fibers, natural carboxylic acids, pectin, or mixtures thereof. In an embodiment, the natural carboxylic acid comprises stearic acid and/or citric acid.

In an embodiment, the sugar composite comprises from about 1 wt-% to about 90 wt-% additive. In an embodiment, the sugar composite comprises from about 5 wt-% to about 60 wt-% additive. In an embodiment, the sugar composite comprises from about 5 wt-% to about 30 wt-% additive. In an embodiment, the sugar composite comprises from about 10 wt-% to about 30 wt-% additive.

In an embodiment, the sugar composite is rigid and inelastic.

In an embodiment, the sugar composites disclosed herein comprise a density of from about 1.2 g/cm³ to about 1.5 g/cm³. In an embodiment, the sugar composites disclosed herein comprise a density of from about 1.3 g/cm³ to about 1.45 g/cm³.

In an embodiment, the sugar composites disclosed herein comprise a flexural strength of from about 14 MPa to about 30 MPa. In an embodiment, the sugar composites disclosed herein comprise a density of from about 16 MPa to about 25 MPa.

In an embodiment, the sugar composites disclosed herein have a flexural modulus of from about 1.3 GPa to about 2.5 GPa. In an embodiment, the sugar composites have a flexural modulus of from about 1.4 GPa to about 2.1 GPa.

In an embodiment, the sugar composites disclosed herein have a compressive strength of from about 50 to about 150 MPa. In an embodiment, the sugar composites disclosed herein have a compressive strength of from about 60 to about 130 MPa.

In an embodiment, the sugar composites disclosed herein have a hardness of from about 84 HD to about 88 HD. In an embodiment, the sugar composites disclosed herein have a hardness of from about 85 HD to about 87 HD.

In an embodiment, the additive increases the flexural strength of the sugar. In an embodiment, the additive increases the flexural strength of the sugar by at least about two-fold. In an embodiment, the additive increases the compressive strength of the sugar. In an embodiment, the additive increases the compressive strength of the sugar by at least about two-fold. In an embodiment, the additive increases the compressive strength of the sugar by at least about five-fold. In an embodiment, the additive increases the compressive strength of the sugar by at least about six-fold. In an embodiment, the additive increases the compressive strength of the sugar by at least about seven-fold.

In an embodiment, the sugar composite has a dissolution rate of about 0.37 g/min. In an embodiment, the additive decreases the dissolution rate of the sugar. In an embodiment, the sugar composite has a dissolution rate of two to 20 times slower than the sugar of the sugar composite. In an embodiment, the sugar composite has a dissolution rate of seven to 12 times slower than the sugar of the sugar composite.

The sugar composite as described herein can have any shape, size, color, and/or level of detail as known in the art for a plastic or polymeric material.

In an embodiment, the sugar composite comprises an additional component. In an embodiment, the sugar composite comprises a dye, a pigment, a fragrance, a solvent, a carrier, a thickener, a solidifying agent, a clarifying agent, a plasticizer, an antioxidant, an antimicrobial, a processing aid, decorations (glitter, etc.), or mixtures thereof.

The sugar composite materials have increased resistance to humidity and temperature fluctuations as compared to the vitrified sugar component. In an embodiment, the sugar composites are unaffected when exposed to relative humidity values below 50% at 20° C. In an embodiment, with relative humidity values above 50% for 1 hour, hardness of the sugar composite is reduced by less than about 20%, less than about 15%, or less than about 10%. In an embodiment, with relative humidity values above 50% for 1 hour, the mass of the sugar composite increases by less than about 10%, less than about 5%, or less than about 1%.

In an embodiment, at least a portion of a sugar composite comprises a coating. In an embodiment, the coating is hydrophobic. In an embodiment, the coating is impermeable to water. In an embodiment, the coating is non-toxic. In an embodiment, the coating is food-safe. In an embodiment, the coating is biodegradable. In an embodiment, the coating comprises cellulose acetate. In an embodiment, the coating comprises shellac. In an embodiment, the coating comprises zein and/or monoglycerides.

In an embodiment, the coating comprises a plasticizer. In an embodiment, the plasticizer comprises triacetin. In an embodiment, the coating comprises plastics, polymer, natural resins, oils, fats, waxes, metals, dyes, decorations, composite materials, or mixtures thereof.

In an embodiment, the coating has a thickness of from about 0.1 nm to about 1,000 μm. In an embodiment, the coating has a thickness of from about 0.5 nm to about 500 μm. In an embodiment, the coating has a thickness of from about 1 μm to about 100 μm. In an embodiment, the coating has a thickness of from about 15 μm to about 50 μm.

In an embodiment, at least a portion of a sugar composite comprises more than one coating. In an embodiment, the coating comprises a primer, followed by a second coating. In an embodiment, the primer comprises shellac. In this embodiment, the primer has a thickness of from about 0.1 nm to about 1,000 μm, and the coating has a thickness of from about 0.1 nm to about 1,000 μm. In an embodiment, the primer has a thickness of from about 0.5 nm to about 500 μm, and the coating has a thickness of from about 1 μm to about 100 μm. In an embodiment, the coating comprises a primer alone.

In an embodiment, the coating increases the mass of the sugar composite by about 0.01% to about 5%. In an embodiment, the coating increases the mass of the sugar composite by about 0.1% to about 1%. In an embodiment, the coating increases the mass of the sugar composite by about 0.1% to about 0.2%.

In embodiments comprising a coating, the coating may be applied to the exterior of the entire sugar composite material, or a portion thereof.

In embodiments comprising a coating, the coating decreases the dissolution rate of the sugar composite by at least about 2-fold, at least about 8-fold, at least about 24-fold, at least about 36-fold, or at least about 84-fold. In an embodiment, a coated sugar composite takes at least one day to fully dissolve in an aqueous environment.

In an embodiment, the coating type and/or thickness is selected for a specific dissolution rate. In an embodiment, the coating type and/or thickness is selected such that the sugar composite will withstand dissolution until the external coating is broken.

In an embodiment, sugar composite materials comprising a coating have increased resistance to humidity and temperature fluctuations as compared to an uncoated composite material. In an embodiment, sugar composites comprising a coating show negligible changes in hardness values when exposed to relative humidity values above 50% at 20° C. for 1 hour. In an embodiment, sugar composites comprising a coating show negligible changes in mass values when exposed to relative humidity values above 50% at 20° C. for 1 hour. In an embodiment, sugar composites comprising a coating show negligible changes in hardness values when exposed to relative humidity values above 50% at 20° C. for 1 hour. In an embodiment, sugar composites comprising a coating show negligible changes in mass values when exposed to relative humidity values up to about 90% at 20° C. for 1 hour. In an embodiment, sugar composites comprising a coating show negligible changes in hardness values when exposed to relative humidity values up to about 90% at 20° C. for 1 hour.

In an embodiment, a sugar composite comprises a coating for decorative, or non-functional, purposes.

In an embodiment, the sugar composite disclosed herein is used for single-use or short-term applications, for example plates, glasses, utensils, decorations, and the like. In an embodiment, the sugar composite disclosed herein is utilized for various applications that are not single use, for example, plates, glasses, utensils, decorations, toys, and the like. In an embodiment, the sugar composition as described herein is utilized in caskets and urns for green burials. In an embodiment, the sugar composition as described herein is utilized in gardening and outdoor applications. In an embodiment, the sugar composition as described herein is utilized in an industrial setting.

In an embodiment, after use the sugar composite is buried in soil, dissolved in an aqueous environment, or recycled. In an embodiment, the sugar composite is dissolved in water. In an embodiment, the water is heated. In an embodiment, the sugar composite degrades after use into non-toxic components. In an embodiment, the sugar composite is broken into smaller pieces and thereafter buried in soil, dissolved in an aqueous environment, or recycled.

In an embodiment, a sugar composite comprising a coating is broken into smaller pieces and thereafter buried in soil, dissolved in an aqueous environment, or recycled. In an embodiment, the sugar composite will dissolve leaving behind only a thin coating.

In an embodiment, the sugar composite material does not comprise a plastic. In an embodiment, the sugar composite material does not comprise a polymer. In an embodiment, the sugar composite material does not comprise crystalline sugar. In an embodiment, the sugar composite does not comprise any toxic, or non-biodegradable components.

Also included in the disclosure herein is a product, or article, that comprises the sugar composite as described herein.

### Methods of Making a Sugar Composite

Included in this disclosure is a method of manufacturing the sugar composite described herein.

In an embodiment, the method comprises mixing together the sugar and at least one additive to form a sugar composite. In an embodiment, the sugar is crystalline. In an embodiment, the sugar is amorphous. In an embodiment, the sugar is liquid. In an embodiment, the sugar is heated. In an embodiment, the sugar is heated to at least about 60° C., at least about 100° C., at least about 150° C., at least about 160° C., at least about 170° C., at least about 180° C., or at least about 190° C. In an embodiment, the sugar is cooled to room temperature, then reheated to 60° C., at least about 100° C., at least about 150° C., at least about 160° C., at least about 170° C., at least about 180° C., or at least about 190° C. prior to additive mixing. In an embodiment, the additive is heated to at least about 60° C., at least about 100° C., at least about 150° C., at least about 160° C., at least about 170° C., at least about 180° C., or at least about 190° C., and at least 30° C. below its degradation temperature to maintain the temperature of the heated sugar during mixing. The sugar and the additive can be mixed together by any means known in the art, for example in a mixer, by hand, stirring, shaking, vibrating, extruding, and the like. In an embodiment, the sugar and additive are mixed until the sugar composite is a homogenous liquid. In an embodiment, the temperature of the heated sugar is maintained for the duration of additive mixing. In an embodiment, the temperature of the heated sugar is reduced prior to additive mixing.

In an embodiment, the sugar is mixed with an additive such that the sugar composite material comprises from 1 wt-% to about 90 wt-% additive. In an embodiment, the sugar composite comprises from about 5 wt-% to about 60 wt-% additive. In an embodiment, the sugar composite comprises from about 5 wt-% to about 30 wt-% additive. In an embodiment, the sugar composite comprises from about 10 wt-% to about 30 wt-% additive. In an embodiment, a maximum amount of additive is an amount wherein the resultant viscosity of the sugar composite reaches a critical point of viscosity that restricts homogenous mixing.

In an embodiment, the liquid sugar composite is then cooled until solid. In an embodiment, the sugar composite is cooled at ambient conditions. In an embodiment, the liquid sugar composite is solidified by any means known in the art, for example in a cooler, a freezer, with a fan, and the like.

In an embodiment, products or articles comprising the sugar composite are manufactured with any method as known for plastics or polymers, including extrusion, molding, 3D printing, casting, thermoforming, compression molding, vacuum forming, heat pressing and the like. In an embodiment, the sugar-based composite material is formed into a product with a mold, injection mold, extruder, laser cutter, hand saw, power saw, drill, plane, chisel, mallet, hammer, and/or sander.

In an embodiment, the solidified sugar composite is made into smaller particles, or pellets. In an embodiment, the sugar composite material is pelletized by any method as known for plastics or polymers, including pelletizing, cutting pieces from the liquid state, or grinding and sieving. In an embodiment, the size of sugar composite pellets ranges from powder (about 20 μm in diameter) to large particles (about 5 mm in diameter). In an embodiment, the size of sugar composite pellets is at least 2.75 mm in diameter.

In an embodiment, sugar composite pellets are used in injection molding to make sugar composite products.

In an embodiment, the method comprising manufacturing or manipulating the sugar composite with a laser cutter. In an embodiment, the method comprising manufacturing or manipulating the sugar composite with wood working tools as known in the art, for example hand saws, power saws, planes, chisels, mallets, hammers, sanders, drills, and the like. In an embodiment, the sugar composite can be mechanically shaped without fracturing or losing structural integrity.

In an embodiment, a method for making the sugar composite material described herein comprises compression molding.

In an embodiment of the method, additional components are added to the sugar composite. The additional components comprise a dye, a pigment, a fragrance, a solvent, a carrier, a thickener, a solidifying agent, a clarifying agent, a plasticizer, an antioxidant, an antimicrobial, a processing aid, decorations (glitter, etc.), or mixtures thereof. In an embodiment, a colorant is added during a pelletizing step prior to injection molding. In an embodiment, the additional components are non-toxic and natural.

In an embodiment, the method of manufacturing a sugar composite comprising manipulating the sugar composite into any shape, size, color, and/or level of detail as known in the art for a plastic or polymeric material.

In an embodiment, the method comprises add a coating to at least a portion of the the sugar composite. In an embodiment, the method comprises applying a primer prior to the coating. The coating and the primer may be applied by any means known in the art. In an embodiment, the coating and/or primer is applied by painting, dipping, spraying, vapor depositing, printing, lithographic techniques, wrapping, and the like.

In a embodiment, the method comprises drying and/or curing the coating and/or primer. The coating and the primer may be cured by any means known in the art. In an embodiment, the coating and/or primer is cured by a photochemical reaction, a polymerization reaction, evaporation, cooling, heating, and the like.

### Methods of Recycling a Sugar Composite Material

Included within this disclosure is a method for recycling the sugar composite material. In an embodiment, the method of recycling comprises grinding the sugar composite into smaller pieces and heating the pieces at a temperature above the glass transition temperature of the sugar composite either to form new products directly from ground pieces or to form pellets by any method as known for plastics or polymers. Ground sugar composite particles or pellets can be further processed by any method as known or plastics or polymers to reform into new products. In an embodiment, the size of sugar composite pellets ranges from powder (about 20 μm in diameter) to large particles (about 5 mm in diameter). In an embodiment, the size of sugar composite pellets is at least 2.75 mm in diameter. In an embodiment, recycled sugar composite products are manufactured by any of the manufacturing methods as described herein.

In an embodiment, the method comprises breaking the composite into smaller pieces followed by heating the pieces to at least about above the glass transition temperature of the sugar and then mixing the softened broken pieces. In an embodiment, recycled sugar composites are then made from the resulting viscous liquid via compression or injection molding, or any other method as known in the art.

In an embodiment, the sugar composite is recycled at least once, at least two times, or at least seven times. In an embodiment, the sugar composite is recycled at least once, at least two times, or at least seven times without a reduction in the mechanical properties or a change in the physical properties of the sugar composite. In an embodiment, the sugar composite is recycled at least once, at least two times, or at least seven times without impact on the flexural strength of the sugar composite.

In an embodiment, the recycling method comprises dissolving the sugar composite in water or solvent or an aqueous solution to separate the sugar from the additive by any known separation technique, including filtration and distillation. In this method, the recovery of sugar is greater than about 50%, greater than about 60%, greater than about 70%, or greater than about 80%. In an embodiment, the recovery of sugar is at least about 80%. If separation is unnecessary, the sugar composite can be ground into pellets or smaller pieces and reused directly, as described herein.

### EXAMPLES

Embodiments of the present disclosure are further defined in the following non-limiting Examples. It should be understood that these Examples, while indicating one or more preferred embodiments, are given by way of illustration only. From the above discussion and these Examples, one skilled in the art can ascertain the essential characteristics of the inventions, and without departing from the spirit and scope thereof, can make various changes and modifications of the embodiments of the inventions to adapt to various usages and conditions. Thus, various modifications of the embodiments, in addition to those shown and described herein, will be apparent to those skilled in the art from the foregoing description. Such modifications are also intended to fall within the scope of the appended claims.

For the Examples disclosed herein, the following methods and materials were used.

Low moisture, crystalline isomalt (LM-PF product), CAS 64519-82-0, was provided by Beneo-Palitinit. The LM-PF isomalt product is a diastereomer with a 1:1 ratio of 6-O-α-D-glucopyranosyl-d-sorbitol (GPS) and 1-O-α-D-glucopyranosyl-D-mannitol dihydrate (GPM). Water content was limited by manufacturer specifications to a maximum of 1%.

Crystalline Erythritol, CAS 149-32-6, was provided by Sweet Nature

Microcrystalline Cellulose (100%), CAS 9004-34-6, average particle size 50 μm, was provided by Thermo Scientific.

Wood flour was provided by System Three.

Cellulose acetate, CAS 9004-35-7, average MW 100,000, was provided by Thermo Scientific.

Triacetin (99%), CAS 102-76-1, was provided by Thermo Scientific.

Acetone, CAS 67-64-1, certified ACS, was provided by Fisher Chemical.

Clear, liquid Zinsser® Bulls Eye® shellac dissolved in ethanol (CAS 64-17-5), isopropanol (CAS 67-63-0), methyl isobutyl ketone (CAS 108-10-1), and water was manufactured by Rust-oleum and procured in both pint and spray cannisters.

Zein (corn protein) confectionary glaze, CAS 9010-66-6 was provided by FloZein products. Cozeen 303N contains ethanol, palm oil, zein, glycerin, citric acid, BHA, BHT and has a specific gravity of 0.90-0.92. MasterCoat Glaze ZZ-F contains ethanol, zein, water, and vegetable oil and has a specific gravity of 0.8-1.0 at 25° C. and a protein content between 14-17%.

Stearic Acid (>98.5%), CAS 57-11-4, was provided by MilliporeSigma Supelco.

Glycerol monostearate, CAS 31566-31-1, molecular weight 358.563, was provided by Thermo Scientific Chemicals.

NH pectin supplied by Modernist Pantry, contains low methoxyl amidated pectic (CAS 9000-69-5), disodium diphosphate (CAS 7758-16-9), dextrose (CAS 77938-63-7) and tricalcium phosphate (CAS 7758-87-4).

Citric acid, crystalline anhydrous, CAS 77-92-9, molecular weigh of 192.12 g/mol was provided by Fisher BioReagents.

Emerald green mica powder was provided by CRAFTISS and Romana black earth natural pigment was provided by Natural Earth Pigment.

Amorphous isomalt was produced by heating crystalline isomalt in a laboratory convection oven to generate fully amorphous isomalt. Although DSC results determined that the melting peak for crystalline isomalt occurred at 144° C., a heating temperature of 170° C. was selected because higher melt temperatures are associated with reduced moisture content after processing in an extruder and improved stability against recrystallization. Modulated DSC results confirmed that decomposition of amorphous isomalt does not occur at high temperatures up to 250° C. Melted isomalt was removed from the oven once it reached a transparent, slightly yellow appearance and liquid physical state; approximately three hours per 100 grams.

When appropriate, additional components (cellulose, wood flour, sawdust, etc.) were incorporated into the liquid isomalt and mixed with a Caframo digital overhead stirrer at a rate of 50 rotations per minute. The resulting composite materials were cooled at laboratory ambient temperature and humidity until solid.

The melt temperatures were determined by the endothermic peak using TA Instruments Q2000 Differential Scanning calorimeter (DSC) with helium gas at purge flow rate of 20 to 25 mL per minute. Specimens were placed in Tzero Aluminum hermetic pans. Ramp DSC scans were heated at a rate of 5.0° C. per minute. Modulated DSC scans were conducted at a rate of 3° C. per minute, modulated ±0.5° C. every 100 seconds.

For Nuclear Magnetic Resonance (NMR) spectroscopy analysis, the specimen was dissolved in DMSO-d6 and D₂O. Undissolved particles were removed with a 2 μm filter and the filtered solute was loaded into a NMR tube. The 1H and 13C NMR experiments were conducted using a 600 MHz magnet. A Bruker AVANCE III 600 MHz NMR spectrometer was used for analyses. Bruker TopSpin 4.0.2 software was used for data processing and integration.

Surface and cross-section morphology characterization was performed using FEI Teneo Field Emission Scanning Electron Microscope (FESEM) under 50 Pa vacuum, 5.00 kV voltage, and 0.10 nA current with an ETD detector. Specimens were coated with a thin layer of gold palladium for 50 seconds using a Cressington sputter coater 108 under 0.08 mbar pressure.

All mechanical testing was performed at laboratory ambient conditions ranging between 33% to 49% relative humidity, or below the measurable humidity limit of the hygrometer, and 18.5° C. to 20.0° C. All specimens were stored in a sealed enclosure over desiccant at ambient temperature prior to testing.

Density was calculated using the values of mass and volume. Dimensions of rectangular specimens were measured by a caliper with precision to 0.01 mm. The accuracy of density calculated from volume measured by calipers was determined to be ±0.06 mm (±4%) verified by volume displacement of pure isomalt in silicone oil.

Hardness measurements were obtained using Rex Gauge Company, Inc Shore D durometer, model 1600, with a Type 2 operating stand and measurement range of 0-100 HD. Indentation measurements were recorded from five locations on the material 6.0 mm apart, four points distributed across four corners and one in the center of the square sheet. The pressure foot was in contact with the specimen surface for five seconds at each measurement point before a hardness reading was recorded. Specimens that were less than 6.0 mm in depth were validated by confirming that the measured hardness value for WF-25 specimens less than 6.0 mm in depth were equivalent to those 6.0 mm or greater in depth; the difference between the measured hardness values was 0.18±0.70 HD.

Four-point bend tests were conducted using an Instron Universal Testing Machine, model 5542, with Merlin analysis software to evaluate the flexural strength at break and flexural elastic modulus. The support span length was 40 mm and the load span length during testing was half of the support span length. Specimens were prepared to closely align with a support span-to-depth of specimen ratio of 16. Five specimens per material were tested. The rate of crosshead motion was calculated using equation 1, following Procedure A of ASTM D6272-17. All specimens fractured completely within the 5% strain limit.

$$R = \frac{0.1 \; 67 {ZL}^{2}}{d} . \qquad Equation 1$$

R=rate of crosshead motion, mm/min,
L=support span, mm,
d=depth of beam, mm, and
Z=rate of straining of the outer fibers, mm/mm. Value used for all tests was 0.01 mm/mm per Procedure A.

Flexural strength was calculated using equation 2, following Procedure A of ASTM D6272-17.

$$S = \frac{3 PL}{4 {bd}^{2}} . \qquad Equation 2$$

S=stress in the outer fiber throughout the load span, MPa,
P=load at a given point on the load-deflection curve, N,
L=support span, mm,
b=width of beam, mm, and
d=depth of beam, mm.

Flexural modulus was calculated using equation 3, following Procedure A of ASTM D6272-17.

$${E}_{B} = \frac{0.17 {L}^{3} m}{{bd}^{3}} . \qquad Equation 3$$

E=modulus of elasticity in bending, MPa,
L=support span, mm,
b=width of beam tested, mm,
d=depth of beam tested, mm, and
M=slope of the tangent to the initial linear region.

Compression testing was performed on an Instron Universal Testing Machine, model 5984, with Bluehill Universal analysis software at a rate of 1.30 mm/min. Testing was performed in accordance with ASTM D695-15. Specimens were cylindrical with a height of the specimens was twice that of the diameter. Five specimens per material were tested. Compressive strength was calculated by dividing the maximum compressive load at break (N) by the original cross-sectional area of the specimen.

### Example 1—Evaluation of Mechanical and Physical Properties of Sugar Composites

Sugar composite materials were created by combining an amorphous isomalt with varying amounts of microcrystalline cellulose (MCC) and wood flour (WF). The maximum limit of additive was determined once the viscosity of the mixture reached a critical point of viscosity that restricted homogenous mixing.

Specimens for testing were created as follows. Solid sugar composite material bulk was crushed by adding four tons of force in a 4 inch×4 inch aluminum heat press mold in a Carver heat press. A total of 66.07±0.39 g of composite material was placed in a 4 inch×4 inch aluminum heat press mold coated with Stoner urethane mold release and heated in a convection oven at 130° C. for 30 minutes, then placed under 4 tons of force in a Carver heat press for five minutes. The pressed material was cooled in the mold to room temperature before removal. Beam shapes for four-point bend testing were cut in a Boss laser cutter at 80% maximum power, 75% minimum power (on turns), and 10 mm/second speed.

Pure amorphous isomalt testing specimens for four-point bend tests were created by pouring melted isomalt into poly(dimethylsilozane) (PDMS) molds in the target dimensions, then cooled at room temperature. For Shore D hardness tests, melted isomalt was poured into a 4 inch×4 inch aluminum heat press mold coated with Stoner urethane mold release, then cooled at room temperature.

For compression tests, the specimens were prepared as follows. The solid composite material bulk was crushed by adding four tons of force in a 4 inch×4 inch aluminum heat press mold in a Carver heat press. A total of 50.0 g of crushed composite material was added to an aluminum cylindrical heat press mold coated with Stoner urethane mold release and heated in a convection oven at 130° C. for 30 minutes, then placed under four tons of force in a Carver heat press for five minutes. The pressed material was cooled in the mold to room temperature before removal.

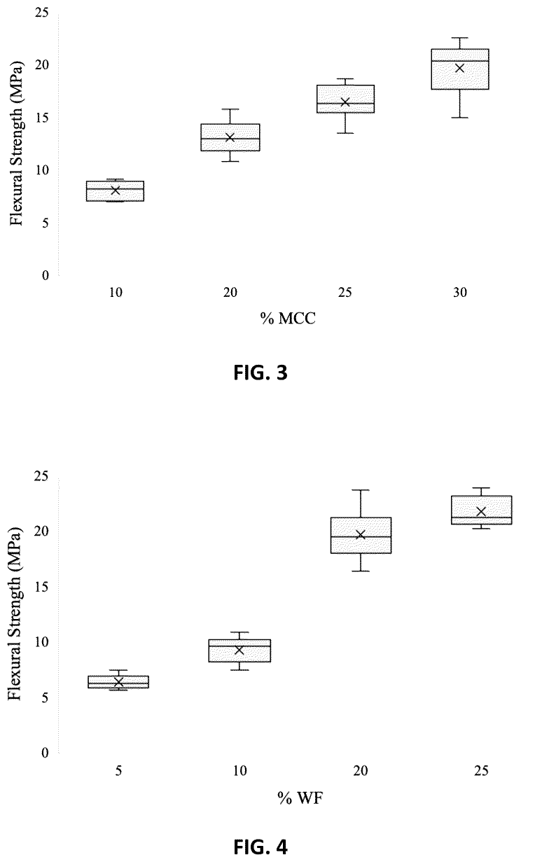

Flexural strength of materials with increasing concentrations of microcrystalline cellulose was evaluated. As shown in FIG. 3, there is a trend of increased flexural strength with incremental increases in the concentration of microcrystalline cellulose. As shown in FIG. 4, a similar trend was observed with increasing concentration of wood flour.

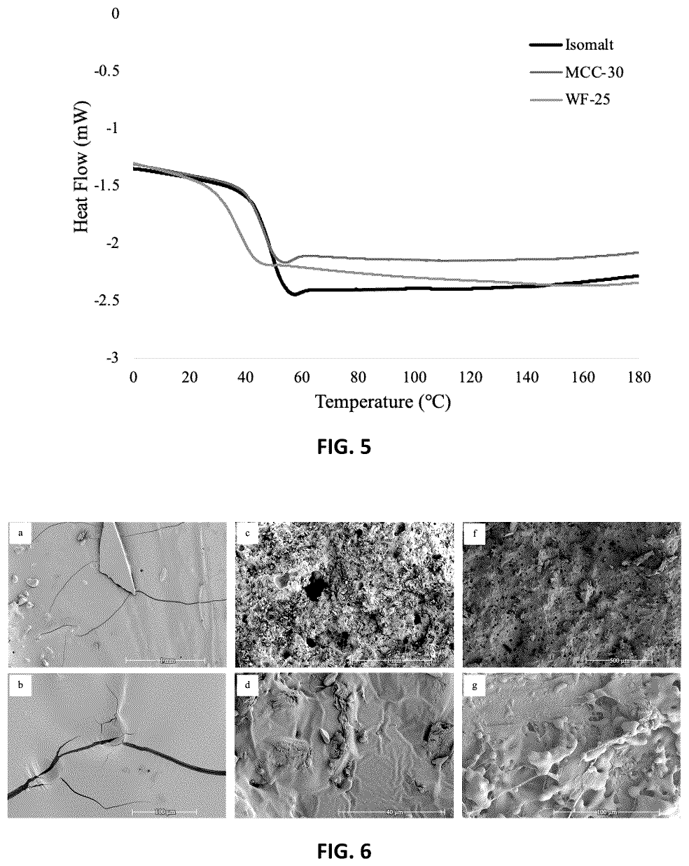

Differential Scanning calorimetry (DSC) was used to evaluate the transition temperatures of the sugar composites containing 30 wt-% MCC (MCC-30) and 25 wt-% WF (WF-25) in order to select an appropriate temperature range for molding. As shown in FIG. 5, the transition temperature of MCC-30 closely followed that of pure isomalt at 46° C. and 48° C., respectively. The transition temperature of WF-25 was approximately 10° C. lower at 37° C.

FESEM images of the composite fracture surface provided a visual indication of the adhesion between isomalt and the additive, fracture character, and defect presence. FIG. 6 shows FESEM images of a cross-section of the fracture surface for a) pure isomalt, 1 mm scale; b) pure amorphous isomalt, 100 μm scale; c) MCC-30, 1 mm scale; d) MCC-30, 40 μm scale; e) WF-25, 500 μm scale; and g) WF-25, 100 μm scale.

As shown in FIG. 6, there was no visible separation between the isomalt and the additive at the matrix-additive interface. Isomalt infiltrated pores and fully coated the surface of the WF fibers and MCC particles. Deep cracks crossing the fracture surface of pure isomalt were not present at the fracture surface of MCC-30 or WF-25. Without being limited to a particular theory, this suggests that compatible additives incorporated into the matrix act as impurities to obstruct crack propagation across the surface and ultimately help to increase the overall strength of the material.

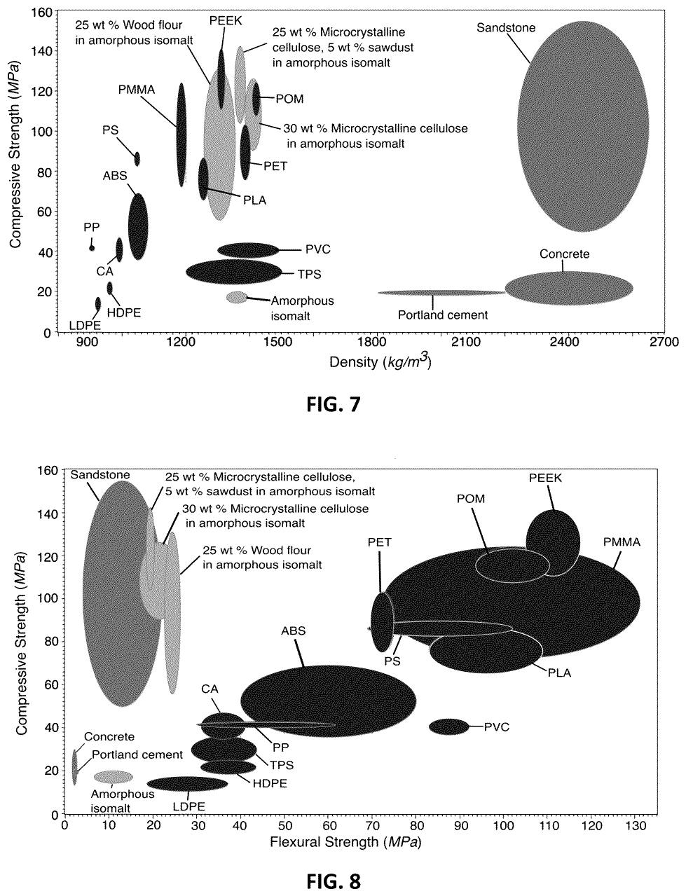

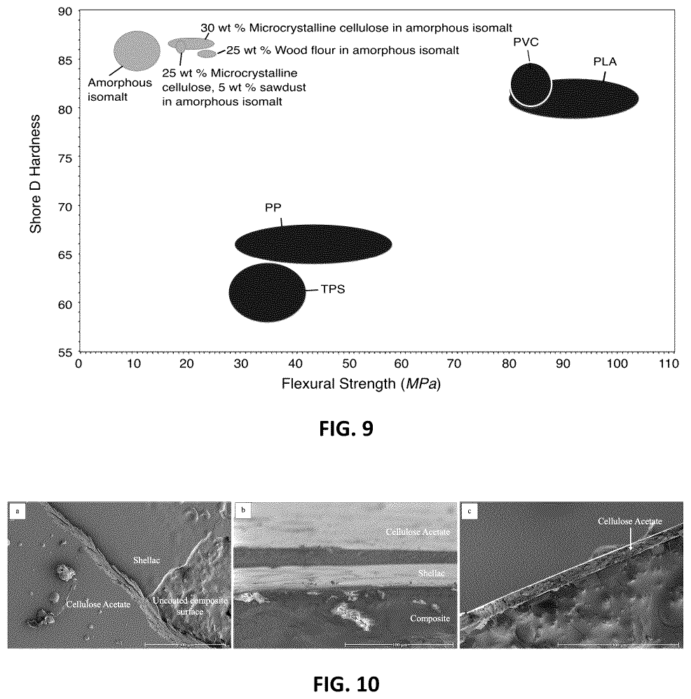

The mechanical and physical properties of various sugar composites are summarized in Table 1 and presented as Ashby Plots in FIG. 7, FIG. 8, and FIG. 9, in comparison to polymers and ceramics. Sugar composites tested included MCC-30, WF-25, a composite with 25 wt-% MCC and 5 wt-% sawdust (MCC-25-SD-05, also labeled as MCC-30-SD-05), and a isomalt control. FIG. 7 shows a materials properties plot depicting compressive strength versus density, FIG. 8 is a plot of compressive strength versus flexural strength, and FIG. 9 depicts Shore D hardness versus flexural strength. No ceramics are portrayed in the FIG. 9 Shore D hardness vs. flexural strength plot because hardness is not measured by the Shore D method for ceramics. Materials data for polymers and ceramics was generated by Granta EduPack 2021.

TABLE 1

| | | Flexural | Flexural | Compressive | |
|---|---|---|---|---|---|
| | Density | Strength | Modulus | Strength | Hardness |
| Material | (g/cm³) | (MPa) | (GPa) | (MPa) | (HD) |
| Isomalt | 1.36 ± 0.03 | 10.66 ± 3.63 | 1.27 ± 0.29 | 17.05 ± 2.76 | 85.9 ± 1.5 |
| MCC-30 | 1.41 ± 0.02 | 22.99 ± 3.52 | 2.01 ± 0.37 | 104.26 ± 13.93 | 86.6 ± 0.5 |
| WF-25 | 1.32 ± 0.04 | 24.46 ± 1.36 | 1.43 ± 0.20 | 95.80 ± 27.64 | 85.5 ± 0.3 |
| MCC-25-SD-05 | 1.37 ± 0.01 | 19.34 ± 0.82 | 1.68 ± 0.11 | 126.53 ± 16.36 | 86.3 ± 0.5 |

With the addition of MCC and WF additives, the flexural strength of isomalt increased by two-fold, while compressive strength increased by five- to seven-fold. The addition of 5% sawdust maximized the compressive strength while maintaining a high flexural strength characteristic of the other sugar composites. The compressive strength of the sugar composites is competitive with common rigid polymers, such as PEEK, PMMA, and POM, as well as ceramics. The compressive strength of sugar composites is more than double the compressive strength of cement and concrete, as well as starch-based thermoplastics. The density of sugar composites is comparable to many thermoplastic polymers, whereas the density of the represented ceramics is roughly twice as high as the sugar composites. Thus, the sugar composites have characteristically low density below 1500 kg/m³, like polymers, combined with high strength, like ceramics. The flexural strength of sugar composites is noticeably lower than rigid polymers, but similar to ceramics in the range of 20 to 25 MPa.

Finally, sugar composites are hard materials and the Shore D hardness values are in the vicinity of 85 to 87 HD, slightly higher than rigid polymers like PVC.

### Example 2—Dissolution Evaluation

Sugar composite specimens were injection molded to ensure uniform rectangular prism shape and size of 5.21±0.01 mm. Pure vitrified isomalt could not be injection molded due to the brittle and fragile nature of the material, so pure vitrified isomalt specimens were cast in PDMS molds formed to target the same shape and size as the sugar composite specimens; specimens were a rectangular prism shape with a size of 6.21±0.21 mm.

Specimens were submerged in 12.6 liters of deionized water in a 20 inch×10 inch rectangular and 12 inch tall glass container. Specimens were placed top of wire mesh with 2.66 mm×3.05 mm gaps splayed over a petri dish. Inside the petri dish and below the wire mesh, the paddles of a Caframo overhead mixer, model BDC250U1, rotated at a rate of 700 rotations per minute to draw excess, undissolved particles through the grate and away from the specimen. The start time of dissolution was recorded when the specimen was placed inside the deionized water and on top of the wire mesh. The stop time of dissolution was recorded when the specimen could no longer be visually detected (uncoated specimens) or when there was a visible color change throughout the specimen (coated specimens, as in Example 3), which indicated that the isomalt, which had a natural yellow tint, was dissolved. Although it was not verified quantitatively that the isomalt was fully dissolved from coated specimens, the purpose of this experiment was to obtain an approximate dissolution rate relative to other coated or uncoated sugar composites, and therefore a visual determination of complete dissolution was considered sufficient

Table 2 summarizes the dissolution time and rate for pure amorphous isomalt, MCC-30, and WF-25. Values represent the average of three specimens per material set.

TABLE 2

| | Dissolution | Dissolution |
|---|---|---|
| | Time | Rate |
| Material | (hh:mm:ss) | (g/min) |
| Isomalt | 00:16:39 ± 00:00:62 | 0.372 ± 0.025 |
| MCC-30 | 01:53:10 ± 00:10:06 | 0.047 ± 0.004 |
| WF-25 | 02:07:12 ± 00:25:00 | 0.040 ± 0.007 |

As summarized in Table 2, there was little difference in the dissolution rates between MCC-30 and WF-25. However, the rate of dissolution for the sugar composites was between seven and twelve times slower than pure isomalt. Without being limited to one particular theory, microcrystalline cellulose and wood flour additives can interact with and obstruct access to the hydroxyl groups of isomalt through intermolecular hydrogen bonds. Upon combination with additives, diffusion of water molecules through the surface of the sugar composites was restricted, which reduced the overall rate of dissolution. The extent of this effect is dependent on the compatibility between the isomalt and the additives, and the hydrophobic character of the additives.

### Example 3—Coating Evaluation

Sugar composites were produced, and dissolution rates evaluated as described in Example 2.

In this Example, a coating was applied to the sugar composite to provide a hydrophobic exterior.

Two natural and biodegradable coatings were selected to harness both adhesion to the sugar composite substrate and hydrophobicity at the surface. Shellac was used as a base coat because it adheres to and wets the surface of the sugar composite in the uncured solvated form, then forms a moderately hydrophobic surface once cured. Shellac is a natural, non-toxic, and biodegradable polymer resin. Sugar composites were dipped in shellac solution, then suspended by a hanging apparatus and exposed to room temperature air until cured.

With the addition of triacetin, a natural plasticizer, a cellulose acetate coating was applied on top of shellac to create a water-impermeable barrier. A total of about 15 wt-% triacetin was added to cellulose acetate powder. Cellulose acetate and triacetin were dissolved in acetone at a ratio of 13:1 percent volume to weight acetone to cellulose acetate power. The sugar composites were dip coated in the cellulose acetate and triacetin solution, then suspended by a hanging apparatus and exposed to room air to dry. Cellulose acetate alone did not adhere well to the sugar composite substrate. Without being limited to one particular theory, the nonpolar functional groups of cellulose acetate are not compatible for adhesion to the polar substrate of the sugar composites, but shellac is a complex molecule with polar and nonpolar regions and binds to both the sugar composites and cellulose acetate. Therefore, the combination of shellac and cellulose acetate layers was used to create a cohesive, layered coating system.

FESEM images were obtained to evaluate the conformity and adhesion of shellac and cellulose acetate coverage over the surface of MCC-30. FIG. 10 contains FESEM images of a) an overhead view of cellulose acetate on top of shellac base coating on top of MCC-30 substrate, 500 μm scale; b) an angled cross-section view of cellulose acetate on top of shellac base coating on top of MCC-30 substrate, 100 μm scale; and c) a perpendicular cross-section view of cellulose acetate on top of shellac base coating (shellac not visible at scale) on top of MCC-30 substrate, 300 μm scale. For the FESEM image in FIG. 10 a), the peeled and then sheared cellulose acetate coating provides a diagonal demarcation between the full coating and the partial coating. The cellulose acetate coating was peeled after a sample was purposely broken, where the force of breaking the sample caused delamination of the cellulose acetate and shellac coatings at the site of the break.

Prior to polymerization, shellac was a solvated liquid when applied to the surface of the sugar composite, which allowed it to fill in and cover rough or uneven areas of the surface before it cured, as shown in FIG. 10. Conversely, cellulose acetate created a smooth and even protective exterior finish. The shellac coating thickness was approximately 600 nm, and ranged from 0.57 nm to 391 μm, where the thicker sections occurred in areas where the shellac accumulated in crevices of the composite surface. The cellulose acetate coating thickness ranged from 19.5 μm to 21.1 μm.

Shellac and cellulose acetate coatings prevented interactions between the surface of the sugar composites with direct water contact over short time scales relevant for use in a variety of single or short-term use applications. When submerged in deionized water, the combined coating system reduced dissolution time by 7 days compared to uncoated systems.

The shellac primer coat caused at least a 36-fold delay in dissolution relative to an uncoated sugar composite. The dual coating of shellac and cellulose acetate caused a 84-fold delay relative to an uncoated sugar composite.

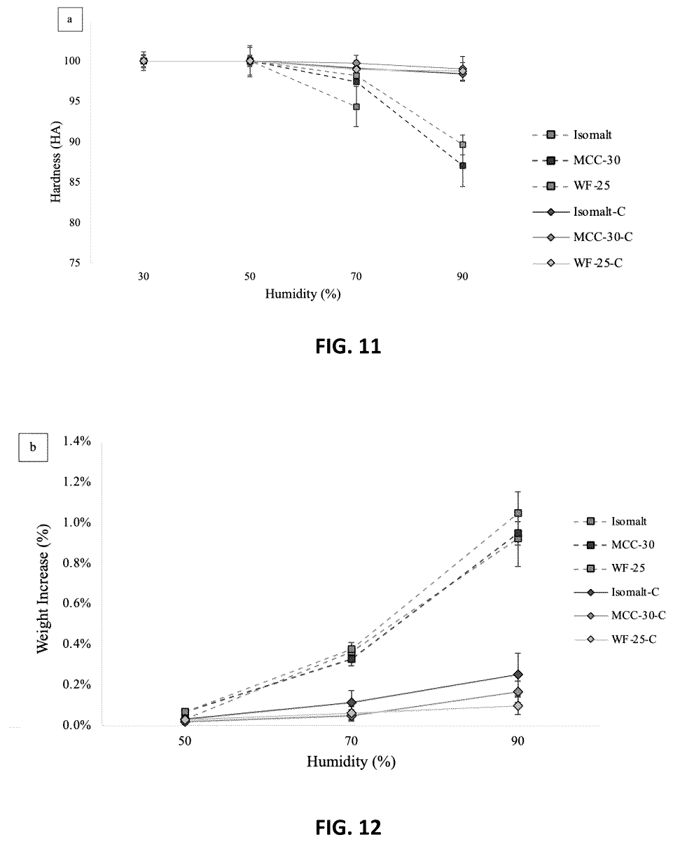

FIG. 11 shows the changes in Shore A hardness and with exposure to incremental increases in relative humidity for uncoated specimens (pure vitrified isomalt, MCC-30, and WF-25) and coated specimens. For these tests, two coats of shellac were sprayed onto the surface of the sugar composite with a compressed air cannister. Shellac was allowed to cure completely between coats and before applying the cellulose acetate top coat. FIG. 12 is a plot of weight with exposure to incremental increases in relative humidity for the same sugar composites. At 90% humidity, pure isomalt was in a viscous liquid form and reliable hardness values could not be obtained. For each material set, values represent the average of three specimens, with the exception of WF-25, which represents the average of two specimens. Vertical lines through each average value indicate the standard deviation of each material set.

Without being limited to one particular theory, the vitrified form of the sugar composite materials is more likely to interact with and absorb atmospheric moisture than the crystalline form. Upon exposure to elevated levels of humidity, pure vitrified isomalt, MCC-30, and WF-25 softened and retained water. All uncoated specimens decreased in hardness and increased in mass between 50-70% humidity, and the trend was accelerated above 70% humidity. However, specimens coated with the shellac and cellulose acetate showed negligible change in hardness values (less than 2 HA) and percent mass increase (less than 0.25%) through 90% humidity as shown in FIG. 11 and FIG. 12.

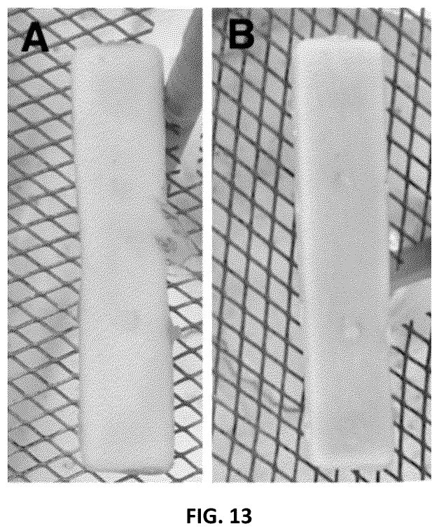

To demonstrate the performance of the sugar composites in short-term water-contact applications, an MCC-30 specimen was coated with shellac and cellulose acetate, then submerged in deionized water over a period of eight hours. Photographs were taken before (A) and after (B) as shown in FIG. 13. There was no apparent change to the appearance of the specimen during submersion. Photographs were taken at different times of the day, thus any slight color difference is due to changes in ambient lighting.

After eight hours of water contact, the specimen was broken in half and again submerged in water to begin the dissolution process. The specimen immediately began to dissolve and was fully dissolved, with only the additive and the coating remaining, after 8 hours. The dissolution process would be further accelerated if submerged in a heated water bath, or crushed to expose more surface area of the sugar composite. This demonstration mimics a variety of product scenarios, such as its survival while used as a single-use utensil, which is then broken up and thrown in a dishwasher to dissolve into non-toxic components, or the short lifetime if littered, broken up, degraded, and dissolved as it is subjected to hydrolysis, abrasive, and/or impact forces in the environment.

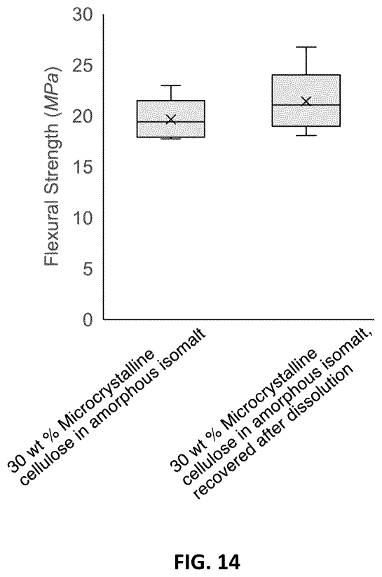

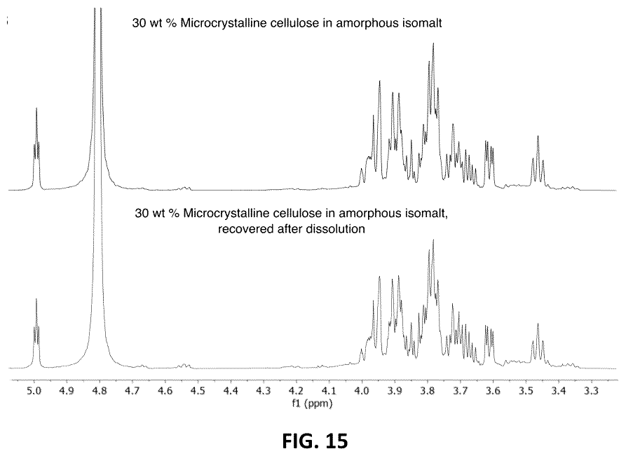

FIG. 14 shows the flexural strength of an MCC-30 sample compared to the same amorphous isomalt material that was recovered after dissolved and separated from the coating. The flexural strength values shown are the average (x) and standard deviations (⊥) of five measurements. The box plot further shows the median flexural strength values as well as the first and third quartiles (□). FIG. 15 shows ¹H NMR spectra of an MCC-30 sample before and after dissolution and recovery. The lack of new peaks in ¹H-NMR spectra, and retention of the isomalt peaks and chemical shift values in ¹H-NMR spectra further indicate that isomalt did not degrade. These data confirm that little physical change occurs upon dissolution and recovery.

### Example 4—Product Demonstration Formulations

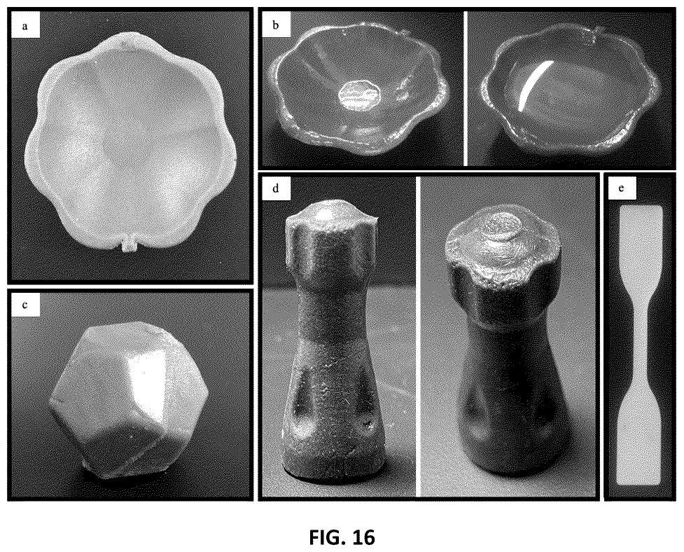

A variety of formations were molded from sugar composite materials by extrusion, injection, and compression molding. In particular, injection molding was successfully used to create product demonstrations from MCC-30. These product demonstrations are shown in FIG. 16. FIG. 16 contains images of object demonstrations formed from injection molding of MCC-30: a) a flower-shaped saucer colored with emerald green mica powder, with dimensions 53.72 mm×55.40 mm across and 15.39 mm tall; b) a flower-shaped saucer coated with shellac, the left image shows the empty saucer and right image was taken one hour after the saucer was filled with deionized water; c) an octahedron colored with emerald green mica powder, with dimensions 17.96 mm×20.07 mm×22.02 mm; d) a rook chess piece colored with black natural pigment, with dimensions 38.16 mm tall and 15.50 mm wide at base and 12.05 mm wide at top; and e) a dog bone shape traditionally used for tensile tests, with dimensions for Type IV under ASTM D628-14 and 4.00 mm in depth.

As shown in FIG. 16, b) there was no observable change in the condition of the coated object during the one-hour water contact period.

In addition, sheets made from sugar composites materials were successfully machined with a band saw and a drill press, which are traditional metal and woodworking tools, while sheets of amorphous isomalt cracked and disintegrated during machining.

### Example 5—Recycling Evaluation

To evaluate changes in flexural strength and hardness with multiple rounds of recycling, an initial batch of sugar composite material was prepared using the methods described in Example 1, from which seven rounds of material would be processed and separated for testing. Additionally, a single sheet of sugar composite material was processed then cut with a Boss laser cutter. The laser cut and bend testing steps were considered relevant for strength determination only, and were not representative of a standard product manufacturing or recycling process; therefore, were removed from subsequent recycling processes to avoid impacting the properties. For each round of recycling, 66.07±0.39 g of sugar composite material was extracted from the batch for laser cutting and testing, and the bulk material would again be processed with heat and pressure.

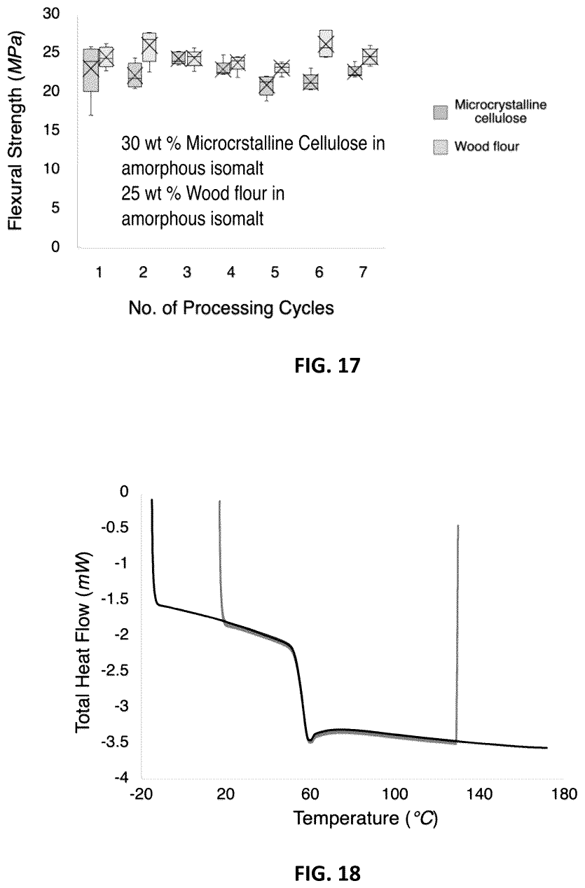

Sugar composites could be repeatedly mechanically recycled without loss of mechanical or thermal properties. After seven cycles of reprocessing by heating, batch mixing, and compression molding, MCC-30 and WF-25 retained flexural strength, as shown in FIG. 17.

Isomalt will degrade into glucose, sorbitol, and mannitol when it undergoes hydrolysis. DSC and NMR were used to evaluate whether these degradation products were present after the seventh processing cycle. Degradation products were expected to appear in a DSC thermogram as additional melt or glass transition peaks: at the melt temperature of mannitol around 165° C., at the glass transition temperature of sorbitol at −5° C., or at the melt temperature of glucose at 146° C. FIG. 18 shows a modulated DSC thermogram of pure amorphous isomalt upon the seventh heat ramp. The DSC temperature fluctuations for cycles one through six were set to mimic the exact temperature profile of six processing cycles. The seventh heat ramp temperature profile was expanded to encompass expected T_{g} or Tₘ peaks of glucose, sorbitol, and mannitol. As can be seen in FIG. 18, modulated DSC results show no change in the T_{g}. Isomalt did not degrade as evidenced by the lack of new thermal transitions.

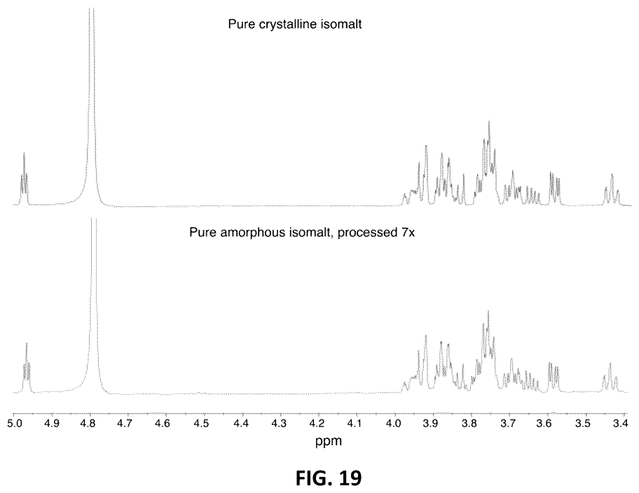

FIG. 19 shows NMR spectra of crystalline isomalt dissolved in DMSO with D₂O and NMR spectra of amorphous isomalt processed seven times. The lack of new peaks in NMR spectra, and retention of the isomalt peaks and chemical shift values in ¹H NMR spectra further indicate that isomalt did not degrade.

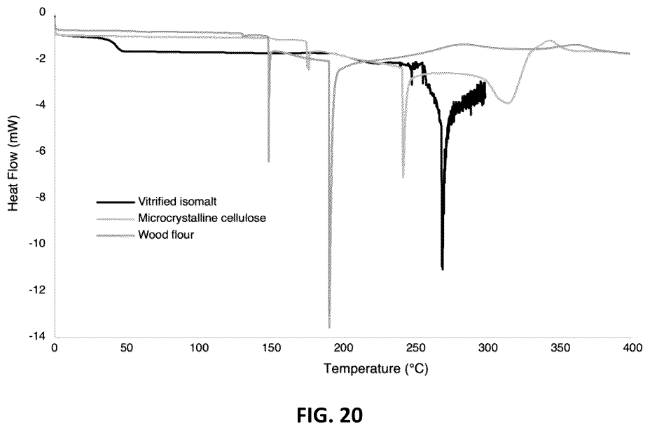

FIG. 20 shows DSC thermograms of isomalt, MCC, and WF. The onset of thermal decomposition of isomalt occurred at about 262° C., WF occurred at about 277° C., and MCC occurred at about 296° C. MCC and WF do not decompose thermally until heated well above the T_{g} value of isomalt, thus the sugar composites comprising MCC and WF can be processed without concern for thermal decomposition.

### Example 6—Various Additives

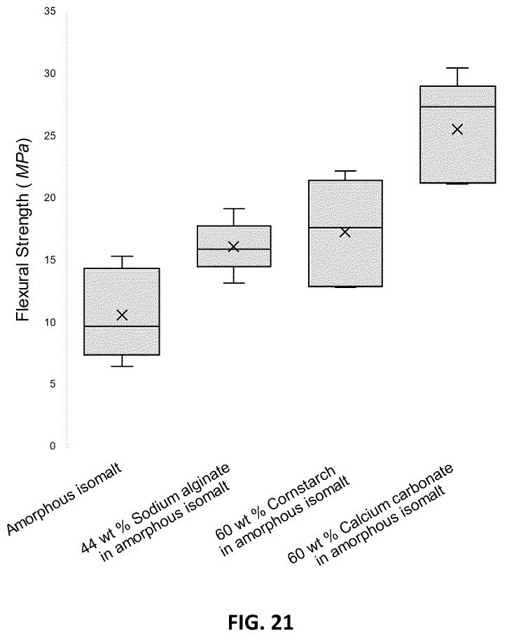

The flexural strength of sugar composites comprising isomalt and different additives was evaluated. Samples were prepared according to Example 1, but with 44 wt-% sodium alginate, 60 wt-% cornstarch, and 60 wt-% calcium carbonate. Flexural strength was tested and is plotted in FIG. 21. The values in FIG. 21 show the average (X) and standard deviations of five measurements. As can be seen from FIG. 21, a variety of additives are compatible with isomalt and can positively impact the properties of isomalt for advantageous sugar composites.

### Example 7—Evaluation of Erythritol+MCC

The properties of the sugar-based composite material erythritol with 5 wt-% and 32 wt-% MCC was evaluated. Erythritol was heated to 130° C. in a laboratory convection oven until melted to a liquid. The melted erythritol was removed from the oven once it reached a transparent, colorless appearance and liquid physical state. The MCC was then added at a ratio of 5 wt-% or 32 wt-% and mixed by stirring to form a viscous homogeneous mixture. The resulting composite material was cooled to ambient temperature and humidity until solid. Prior to mechanical testing, the composition material was reheated to 130° C. and pressed with up to two tons of pressure on a Carver heat press to form a flat sheet.

Specimens for four-point bend and hardness mechanical testing were created as follows. Solid sugar composite material bulk was placed in a 4-inch by 4-inch aluminum heat press mold coated with Stoner urethane mold release and heated in a convection oven at 130° C. for one hour, then placed under two tons of force in a Carver Heat press for five minutes. The pressed material was cooled in the mold to room temperature before removal. Beam shapes for four-point bend testing were cut in a Boss laser cutter at 80% maximum power, 75% minimum power (on turns), and 10 mm/second speed.

The density was calculated to be about 1.40 g/cm³ and the Shore D Hardness was 85.3±1.4 HD.

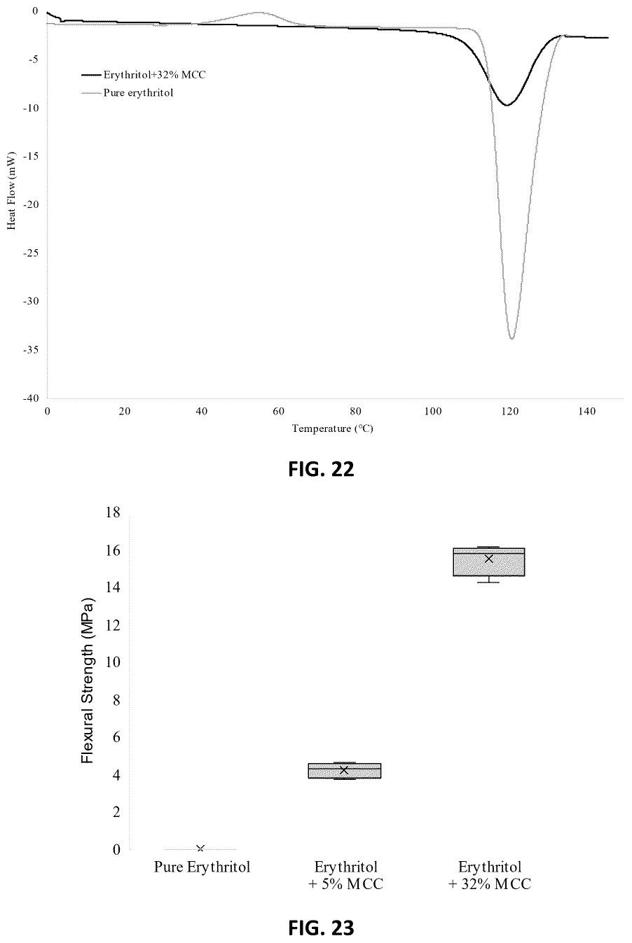

FIG. 22 displays a DSC thermogram comparing the thermal transitions of pure crystalline erythritol and erythritol combined with 32 wt % MCC. The melting peak of pure erythritol at 120° C. remains unchanged when combined with 32 wt % MCC.

Flexural strength of erythritol-based materials with increasing concentrations of MCC is shown in FIG. 23. Samples of pure erythritol, which were melt processed and cast in a mold, shattered upon removal from the mold and were not strong enough to obtain a value for flexural strength by four-point bend tests.

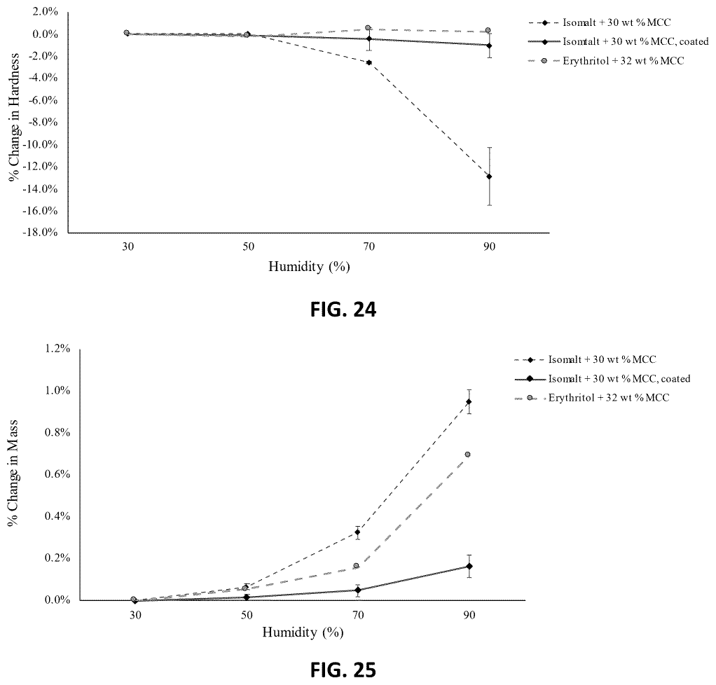

FIG. 24 shows the changes in Shore A hardness with exposure to incremental increases in relative humidity for uncoated specimens of erythritol+32 wt-% MCC and compared to isomalt composite materials and isomalt composite materials coated with shellac then cellulose acetate. Specimens were held at each humidity level for one hour and the temperature was maintained at 20° C. Erythritol combined with 32 wt-% MCC shows negligible change in hardness when exposed to elevated humidity, through 90% relative humidity. The stability in hardness of the uncoated erythritol material at elevated humidity is comparable to that of isomalt composite samples that were coated with shellac then cellulose acetate.

FIG. 25 shows the changes in mass with exposure to incremental increases in relative humidity for uncoated specimens of erythritol+32 wt-% MCC and compared to isomalt composite materials. Erythritol+32 wt-% MCC accumulated less than 0.25% of mass from water through 70% humidity. The increase in mass through 90% humidity may be due to observed water deposition on the surface of the specimen.

### Example 8—Evaluation of Zein and Glycerol Monostearate Coatings

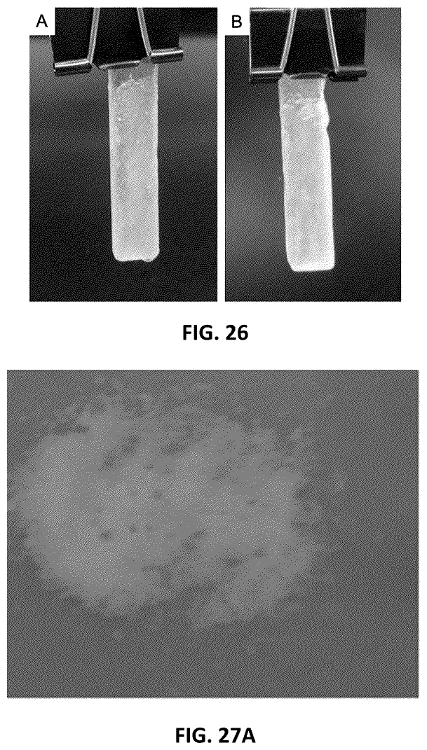

The surface of pure melt-processed isomalt samples were brushed with zein products Cozeen 303N or MasterCoat Glaze. The samples were stored over desiccant prior to the coating application and then suspended from the uncoated end of the sample to dry for 90 minutes. In each instance, the coating was dry and hard after 90 minutes. FIG. 26 shows photographs of the samples. Image A is the isomalt sample coated with Cozeen 303N and image B is the isomalt sample coated with MasterCoat Glaze ZZ-F. As shown in FIG. 26, image A, Cozeen 303N formed an uneven and thick layer of clear, bright yellow viscous solution with visible clumps. The coating adhered to the surface of the isomalt sample. As shown in FIG. 26, image B, MasterCoat Glaze formed a homogenous and thick layer of clear, slightly yellow viscous solution that adhered to the surface of the isomalt sample.

A single layer of glycerol monostearate powder was applied on the flat surface of a sheet of isomalt and 30 wt-% MCC. The coated sample was heated in a laboratory convection oven at 70° C. for 30 minutes until the glycerol monostearate layer became a clear and colorless liquid. The sheet remained solid during the heat treatment. The sheet was removed from heat and cooled at ambient temperature and humidity. After about 30 minutes, the glycerol monostearate surface was a white, waxy, soft solid. The coated area of the sample did not dissolve or change appearance when water droplets were placed on the surface.

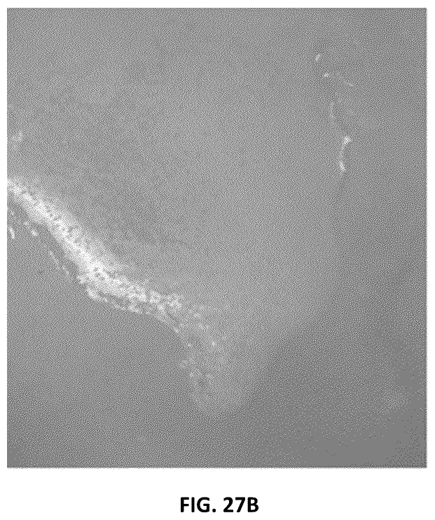

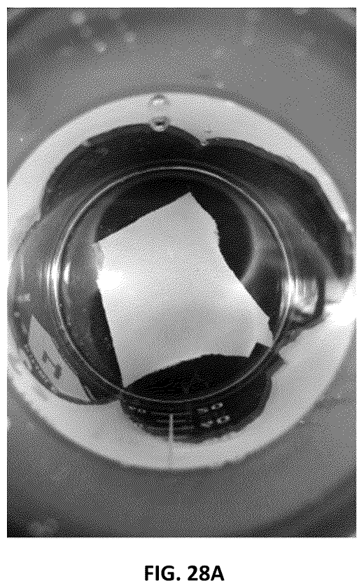

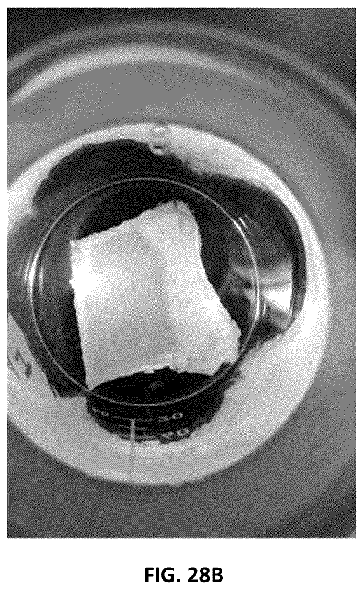

A single layer of glycerol monostearate powder was applied to the flat surface of a sheet of isomalt and 30 wt-% MCC as shown in FIG. 27A. The coated sample was heated in a laboratory convection oven at 70° C. for 30 minutes until the glycerol monostearate layer became a clear and colorless liquid. The sheet remained solid during the heat treatment. The sheet was removed from heat and cooled at ambient temperature and humidity. After about 30 minutes, the glycerol monostearate surface because a clear colorless solid that adhered to the sample sheet surface, as shown in FIG. 27B. The coated area of the sample did not dissolve or change appearance when water droplets were placed on the surface. The sheet was submerged in water. Within one hour, uncoated regions dissolved and disintegrated, while coated regions remained intact and undissolved until the water diffused through the uncoated regions of the sample. FIG. 28A shows a portion of the sheet submerged in deionized water after 1 second, while FIG. 28B shows a portion of the sheet submerged after two hours. The change in color in FIG. 28B indicated the demarcation of uncoated regions (white) to coated regions (yellow) of the sample.

### Example 9— Evaluation of Pectin, Stearic Acid, and Citric Acid Additives

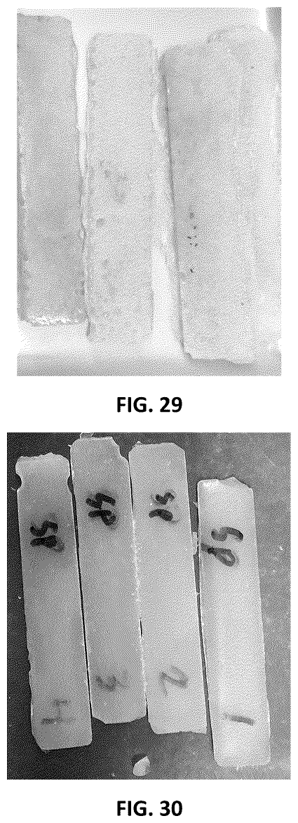

Melted isomalt was placed on a hot plate set to 90° C. About 2.0 grams of NH pectin was mixed into 50.0 grams of melted isomalt using an overhead stir bar at 100 rpm for 10 minutes until a viscous and homogenous mixture was formed. The mixture was poured into rectangular PDMS molds and cooled at ambient temperature and humidity. The resulting composite material of isomalt and 4 wt-% pectin was a hard, rigid, opaque, and slightly yellow solid as shown in FIG. 29. The average flexural strength of the sugar-based composite material was 6.2±2.6 MPa.

Melted sorbitol was placed on a hot plate set to 100° C. About 2.0 grams of NH pectin was mixed into 50.0 grams of melted sorbitol using an overhead stir bar at 100 rpm for 10 minutes until a viscous and homogeneous mixture formed. The mixture was poured into rectangular PDMS molds and cooled at ambient temperature and humidity. The resulting composite material of sorbitol and 4 wt-% pectin was a hard, rigid, opaque, and slightly yellow solid as shown in FIG. 30. The average flexural strength of the sugar-based composite material was 9.6±1.4 MPa.

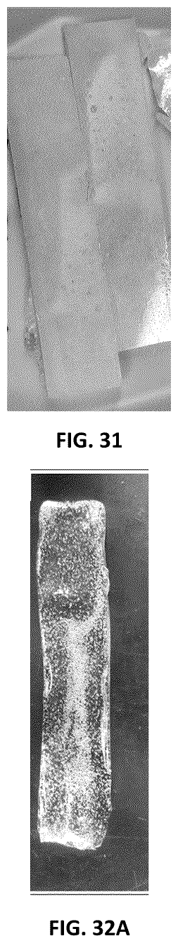

Melted isomalt was placed on a hot plate set to 90° C. About 0.5 grams of stearic acid was mixed into 50.0 grams of melted isomalt using an overhead stir bar at 100 rpm for 10 minutes until a viscous and homogenous mixture was formed. The mixture was poured into rectangular PDMS molds and cooled at ambient temperature and humidity. The resulting composite material of isomalt and 1 wt-% stearic acid was a hard, rigid, opaque, and white solid as shown in FIG. 31. The average flexural strength of the sugar-based composite material was 9.9±0.07 MPa.

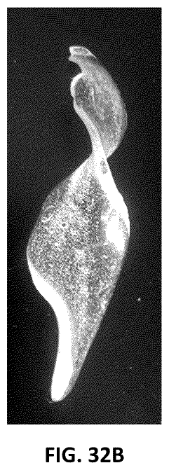

20.0 grams of powdered crystalline d-sorbitol was mixed with 8.6 grams of powdered citric acid in a 600 mL beaker. The crystalline mixture was heated in a convection oven at 130° C. for approximately 90 minutes until a clear and colorless solution formed. The viscous liquid was removed from the heat and poured into PDMS molds and cooled at ambient temperature and humidity. The samples were stored over desiccant prior to testing. The resulting composite material of sorbitol and citric acid was a clear, colorless, flexible solid as shown in FIG. 32A and FIG. 32B. FIG. 32A is a photograph of the composite material after cast into a mold and cooled. FIG. 32B is a photograph of the same composite material twisted into a curled shape.

The present disclosure is further defined by the following numbered embodiments.
1. A recyclable sugar-based composite material comprising a vitrified small molecule sugar, and an additive.
2. The composite material of embodiment 1, wherein the small molecule sugar comprises isomalt, sorbitol, erythritol, mannitol, maltitol, xylitol, sucrose, ribose, xylose, galactose, mannose, sorbose, maltose, lactose, lactulose, trehalose, or mixtures thereof.
3. The composite material of any one of embodiments 1-2, wherein the small molecule sugar comprises isomalt.
4. The composite material of any one of embodiments 1-3, wherein the small molecule sugar comprises vitrified isomalt.
5. The composite material of any one of embodiments 1-4, wherein the additive is a plant-based additive.
6. The composite material of any one of embodiments 1-5, wherein the additive comprises wood flour, sawdust, calcium carbonate, casein, cellulose, cellulose derivatives, hemp, grass, salt, sodium chloride, wheat gluten, white flour, kaolin, starch, crushed glass, agricultural waste, chitosan, chitin, algae, algae derivatives, fabrics, fibers, plant fibers, or mixtures thereof.
7. The composite material of any one of embodiments 1-6, wherein the sugar-based composite material comprises from about 5 wt-% to about 60 wt-% additive, or from about 5 wt-% to about 30 wt-% additive.
8. The composite material of any one of embodiments 1-7, wherein the sugar-based composite material has a density of from about 1.2 g/cm³ to about 1.5 g/cm³, or from about 1.3 g/cm³ to about 1.45 g/cm³.
9. The composite material of any one of embodiments 1-8, wherein the sugar-based composite material has a flexural strength of from about 15 MPa to about 30 MPa, or from about 18 MPa to about 25 MPa.
10. The composite material of any one of embodiments 1-9, wherein the sugar-based composite material has a flexural modulus of from about 1.3 GPa to about 2.5 GPa, or from about 1.4 GPa to about 2.1 GPa.
11. The composite material of any one of embodiments 1-10, wherein the sugar-based composite material has a compressive strength of from about 50 to about 150 MPa, or from about 60 to about 130 MPa.
12. The composite material of any one of embodiments 1-11, wherein the sugar-based composite material has a hardness of from about 84 HD to about 88 HD, or from about 85 HD to about 87 HD.
13. The composite material of any one of embodiments 1-12, wherein the sugar-based composite material has a dissolution rate of at least about two to about twenty times slower than the vitrified small molecule sugar, or from about seven to about twelve times slower than the vitrified small molecule sugar.
14. The composite material of any one of embodiments 1-13, wherein the sugar-based composite material further comprises a dye, a pigment, a fragrance, a solvent, a carrier, a thickener, a solidifying agent, a clarifying agent, a plasticizer, an antioxidant, an antimicrobial, a processing aid, a decoration, or mixtures thereof.
15. The composite material of any one of embodiments 1-14, wherein the sugar-based composite material has increased resistance to humidity and temperature fluctuations as compared to the vitrified small molecule sugar.
16. The composite material of any one of embodiments 1-15, wherein a hardness measurement of the sugar-based composite material is reduced by less than about 20%, less than about 15%, or less than about 10% at a relative humidity above 50% when exposed for 1 hour.
17. The composite material of any one of embodiments 1-16, wherein the mass of the sugar-based composite material increases by less than about 10%, less than about 5%, or less than about 1% at a relative humidity above 50% when exposed for 1 hour.
18. The composite material of any one of embodiments 1-17, wherein at least a portion of the sugar-based composite material further comprises a coating.
19. The composite material of embodiment claim 18, wherein the coating is hydrophobic.
20. The composite material of any one of embodiments 18-19, wherein the coating is non-toxic and food safe.
21. The composite material of any one of embodiments 18-20, wherein the coating is biodegradable.
22. The composite material of any one of embodiments 18-21, wherein the coating comprises cellulose acetate.
23. The composite material of any one of embodiments 18-22, wherein the coating comprises a plasticizer.
24. The composite material of any one of embodiments 18-23, wherein the coating comprises plastics, polymer, natural resins, oils, fats, waxes, metals, dyes, decorations, composite materials, or mixtures thereof.
25. The composite material of any one of embodiments 18-24, wherein the coating has a thickness of from about 0.1 nm to about 1,000 nm, or from about 0.5 nm to about 500 nm, or from about 1 nm to about 100 nm, or from about 15 nm to about 50 nm.
26. The composite material of any one of embodiments 18-25, wherein the sugar-based composite material comprises more than one coating.
27. The composite material of embodiment 26, wherein the sugar-based composite material comprises a primer, followed by a coating.
28. The composite material of embodiment 27, wherein the primer has a thickness of from about 0.1 nm to about 1,000 nm and the coating has a thickness of from about 0.1 nm to about 1,000 nm, or the primer has a thickness of from about 0.5 nm to about 500 nm and the coating has a thickness of from about 1 nm to about 100 nm.
29. The composite material of any one of embodiments 18-28, wherein the coating increases the mass of the sugar composite by about 0.01% to about 5%, or by about 0.1% to about 1%, or by about 0.1% to about 0.2%.
30. The composite material of any one of embodiments 18-29, wherein the coating decreases the dissolution rate of the sugar-based composite material by at least about 2-fold, at least about 8-fold, at least about 24-fold, at least about 36-fold, or at least about 84-fold.
31. The composite material of any one of embodiments 18-30, wherein the change in mass of the sugar-based composite material is negligible when exposed to relative humidity values up to about 90% at 20° C.
32. The composite material of any one of embodiments 18-31, wherein the change in hardness values of the sugar-based composite material is negligible when exposed to relative humidity values up to about 90% at 20° C.
33. The composite material of any one of embodiments 1-32, wherein the sugar-based composite material is used for single-use or short-term applications.
34. The composite material of any one of embodiments 1-32, wherein the sugar-based composite material is buried in soil, dissolved in an aqueous environment, or recycled after use.
35. The composite material of embodiment 34, wherein the sugar-based composite material is first broken into smaller pieces before buried in soil, dissolved in an aqueous environment, or recycled.
36. The composite material of any one of embodiments 1-32, wherein the sugar-based composite material does not comprise any toxic, or non-biodegradable components.
37. A method of making a sugar-based composite material, the method comprising combining a vitrified small molecule sugar and an additive to form a sugar-based composite material.
38. The method of embodiment 37, wherein the vitrified small molecule sugar is heated and liquified prior to mixing with the additive.
39. The method of any one of embodiments 37-38, wherein the sugar-based composite material is homogeneous.
40. The method of any one of embodiments 37-39, wherein the small molecule sugar comprises isomalt, sorbitol, erythritol. mannitol, maltitol, xylitol, sucrose, ribose, xylose, galactose, mannose, sorbose, maltose, lactose, lactulose, trehalose, or mixtures thereof.
41. The method of any one of embodiments 37-40, wherein the small molecule sugar comprises isomalt.
42. The method of any one of embodiments 37-41, wherein the small molecule sugar comprises vitrified isomalt.
43. The method of any one of embodiments 37-42, wherein the additive is a plant-based additive.
44. The method of any one of embodiments 37-43, wherein the additive comprises cellulose, wood flour, sawdust, calcium carbonate, casein, cellulose, cellulose derivatives, hemp, grass, salt, sodium chloride, wheat gluten, white flour, kaolin, starch, crushed glass, agricultural waste, chitosan, chitin, algae, algae derivatives, fabrics, fibers, plant fibers, or mixtures thereof.
45. The method of any one of embodiments 37-44, wherein the sugar-based composite material comprises from about 5 wt-% to about 60 wt-% additive, or from about 5 wt-% to about 30 wt-% additive.
46. The method of any one of embodiments 37-45, wherein the sugar and the additive are combined by mixing, stirring, shaking, and/or vibrating.
47. The method of any one of embodiments 38-46, wherein the liquid sugar-based composite is cooled until solid.
48. The method of any one of embodiments 37-46, wherein the sugar-based composite material is thereafter formed into a product by extrusion, molding, 3D printing, casting, thermoforming, compression molding, vacuum forming, and/or heat pressing.
49. The method of embodiment 46, wherein the solid sugar-based composite is pelletized by pelletizing, cutting pieces from the liquid state, or grinding and sieving.
50. The method of embodiment 49, wherein the pelletized sugar-based composite is formed into a product by injection molding.
51. The method of any one of embodiments 47-50, wherein the sugar-based composite material is formed into a product with a mold, injection mold, extruder, laser cutter, hand saw, power saw, drill, plane, chisel, mallet, hammer, and/or sander.
52. The method of any one of embodiments 37-51, wherein the sugar-based composite material further comprises a dye, a pigment, a fragrance, a solvent, a carrier, a thickener, a solidifying agent, a clarifying agent, a plasticizer, an antioxidant, an antimicrobial, a processing aid, a decoration, or mixtures thereof.
53. The method of any one of embodiments 47-52, wherein the method further comprises applying a coating to at least a portion of the sugar-based composite.
54. The method of embodiment 53, wherein the coating is applied by painting, dipping, spraying, vapor depositing, printing, lithographic techniques, and/or wrapping.
55. The method of any one of embodiments 53-54 wherein the method comprises applying a primer to the sugar-based composite prior to the coating.
56. The method of embodiment 55, wherein the primer is applied by painting, dipping, spraying, vapor depositing, printing, lithographic techniques, and/or wrapping.
57. The method of any one of embodiments 53-56, wherein the method comprises curing the coating and/or primer.
58. The method of embodiments 57, wherein the coating or primer is cured by a photochemical reaction, a polymerization reaction, evaporation, cooling, and/or heating.
59. A method of recycling a sugar-based composite material comprising grinding a sugar-based composite material comprising a vitrified small molecule sugar and an additive into smaller pieces, heating the pieces at a temperature above the glass transition temperature of the vitrified small molecule sugar to form pellets, and forming the pellets into recycled sugar composite materials.
60. The method of embodiment 59, wherein the pellets are formed by pelletizing, cutting pieces from the liquid state, or grinding and sieving.
61. The method of any one of embodiments 59-60, wherein the pellets are formed into recycled sugar-based composite materials by extrusion, molding, 3D printing, casting, thermoforming, compression molding, vacuum forming, and/or heat pressing.
62. The method of any one of embodiments 59-60, wherein the small molecule sugar comprises isomalt, sorbitol, erythritol. mannitol, maltitol, xylitol, sucrose, ribose, xylose, galactose, mannose, sorbose, maltose, lactose, lactulose, trehalose, or mixtures thereof.
63. The method of any one of embodiments 59-62, wherein the small molecule sugar comprises isomalt.
64. The method of any one of embodiments 59-63, wherein the small molecule sugar comprises vitrified isomalt.
65. The method of any one of embodiments 59-64, wherein the additive is a plant-based additive.
66. The method of any one of embodiments 59-65, wherein the additive comprises wood flour, sawdust, calcium carbonate, casein, cellulose, cellulose derivatives, hemp, grass, salt, sodium chloride, wheat gluten, white flour, kaolin, starch, crushed glass, agricultural waste, chitosan, chitin, algae, algae derivatives, fabrics, fibers, plant fibers, or mixtures thereof.
67. The method of any one of embodiments 59-66, wherein the sugar-based composite material comprises from about 5 wt-% to about 60 wt-% additive, or from about 5 wt-% to about 30 wt-% additive.
68. The method of any one of embodiments 59-67, wherein the sugar-based composite material further comprises a dye, a pigment, a fragrance, a solvent, a carrier, a thickener, a solidifying agent, a clarifying agent, a plasticizer, an antioxidant, an antimicrobial, a processing aid, a decoration, or mixtures thereof.
69. The method of any one of embodiments 59-68, wherein at least a portion of the sugar-based composite material further comprises a coating.
70. The method of embodiment 69, wherein the coating comprises cellulose acetate.
71. The method of any one of embodiments 69-70, wherein the coating comprises a plasticizer.
72. The method of any one of embodiments 69-71, wherein the coating comprises plastics, polymer, natural resins, waxes, oils, fats, metals, dyes, decorations, composite materials, or mixtures thereof.
73. A method of recycling a sugar-based composite comprising dissolving the sugar-based composite material of any one of embodiments 1-36 in an aqueous environment to separate the small molecule sugar from the additive, and recovering the small molecule sugar.
74. The method of embodiment 73, wherein the recovery of the small molecule sugar is greater than about 50%, greater than about 60%, greater than about 70%, or greater than about 80%.

The above disclosure is intended to be illustrative and not exhaustive. This description will suggest many variations and alternatives to one of ordinary skill in this art. All these alternatives and variations are intended to be included within the scope of the following claims where the term “comprising” means “including, but not limited to”. Those familiar with the art may recognize other equivalents to the specific embodiments described herein which equivalents are also intended to be encompassed by the following claims.

What is claimed is:

1. A sugar-based composite material comprising:
a melt-processed small molecule sugar comprising a sugar alcohol, and from about 5 wt-% to about 60 wt-% of an additive.

2. The sugar-based composite material of claim 1, wherein the small molecule sugar comprises isomalt, vitrified isomalt, sorbitol, erythritol, mannitol, maltitol, xylitol, sucrose, ribose, xylose, galactose, mannose, sorbose, maltose, lactose, lactulose, trehalose, sucrose octaacetate, or a mixture thereof.

3. The sugar-based composite material of claim 1, wherein the additive comprises wood flour, sawdust, calcium carbonate, casein, cellulose, cellulose derivatives, hemp, grass, salt, sodium chloride, wheat gluten, white flour, kaolin, starch, crushed glass, agricultural waste, chitosan, chitin, algae, algae derivatives, fabrics, fibers, plant fibers, natural carboxylic acids, pectin, or mixtures thereof, and wherein the sugar-based composite material optionally further comprises a dye, a pigment, a fragrance, a solvent, a carrier, a thickener, a solidifying agent, a clarifying agent, a plasticizer, an antioxidant, an antimicrobial, a processing aid, a decoration, or mixtures thereof.

4. The sugar-based composite material of claim 1, wherein the sugar-based composite material has a density of from about 1.2 g/cm3 to about 1.5 g/cm3, a flexural strength of from about 14 MPa to about 30 MPa, a flexural modulus of from about 1.3 GPa to about 2.5 GPa, a compressive strength of from about 50 to about 150 MPa, and a hardness of from about 84 HD to about 88 HD.

5. The sugar-based composite material of claim 1, wherein the sugar-based composite material has a dissolution rate of at least about two to about twenty times slower than the small molecule sugar, increased resistance to humidity and temperature fluctuations as compared to the small molecule sugar, a hardness measurement that is reduced by less than about 20% at a relative humidity above 50% when exposed for 1 hour, and wherein the mass of the sugar-based composite material increases by less than about 10% at a relative humidity above 50% when exposed for 1 hour.

6. The sugar-based composite material of claim 1, wherein at least a portion of the sugar-based composite material further comprises at least one coating, and optionally wherein the sugar-based composite material comprises a primer between at least a portion of the sugar-based composition and at least a portion of the coating.

7. The sugar-based composite material of claim 6, wherein the coating is hydrophobic, non-toxic, food safe, and/or is biodegradable.

8. The sugar-based composite material of claim 6, wherein the coating comprises cellulose acetate, zein, monoglycerides, a plastic, a polymer, a natural resin, a plasticizer, oils, fats, waxes, metals, dyes, decorations, composite materials, or mixtures thereof.

9. The sugar-based composite material of claim 6, wherein the coating decreases a dissolution rate of the sugar-based composite material by at least about 2-fold, wherein a change in mass of the sugar-based composite material is negligible when exposed to relative humidity values up to about 50% at 20° C. for 1 hour, and wherein a change in hardness values of the sugar-based composite material is negligible when exposed to relative humidity values up to about 50% at 20° C. for 1 hour.

10. A method of making a sugar-based composite material, the method comprising:
combining a melt-processed small molecule sugar comprising a sugar alcohol with from
about 5 wt-% to about 60 wt-% of an additive to form a sugar-based composite material,
wherein the small molecule sugar is heated and liquified prior to mixing with the additive, and
wherein the sugar-based composite material is a solid at room temperature.

11. The method of claim 10, wherein the small molecular sugar comprises isomalt, sorbitol, erythritol, mannitol, maltitol, xylitol, sucrose, ribose, xylose, galactose, mannose, sorbose, maltose, lactose, lactulose, trehalose, sucrose octaacetate, or mixtures thereof, and the additive comprises cellulose, wood flour, sawdust, calcium carbonate, casein, cellulose, cellulose derivatives, hemp, grass, salt, sodium chloride, wheat gluten, white flour, kaolin, starch, crushed glass, agricultural waste, chitosan, chitin, algae, algae derivatives, fabrics, fibers, plant fibers, natural carboxylic acids, pectin, or mixtures thereof, and wherein the sugar and the additive are combined by mixing, stirring, shaking, and/or vibrating.

12. The method of claim 10, wherein the sugar-based composite material is thereafter formed into a product by cooling until solid, extrusion, molding, 3D printing, casting, thermoforming, compression molding, vacuum forming, pelletizing, injection molding, laser cutting, hand sawing, power sawing, drilling, and/or heat pressing, by plane, chisel, mallet, hammer, and/or sander.

13. The method claim 10, comprising combining the sugar-based composite material with a dye, a pigment, a fragrance, a solvent, a carrier, a thickener, a solidifying agent, a clarifying agent, a plasticizer, an antioxidant, an antimicrobial, a processing aid, a decoration, or mixtures thereof.

14. The method claim 10, wherein the method further comprises applying at least one coating to at least a portion of the sugar-based composite, optionally applying a primer to the sugar-based composite prior to the coating, and optionally curing the coating and/or primer.

15. The method of claim 10, wherein the coating and/or the primer is applied by painting, dipping, spraying, vapor depositing, printing, lithographic techniques, and/or wrapping and wherein the curing is by a photochemical reaction, a polymerization reaction, evaporation, cooling, and/or heating.

16. A method of recycling a sugar-based composite material comprising:
breaking a sugar-based composite material comprising a melt-processed small molecule sugar comprising a sugar alcohol and about 5 wt-% to about 60 wt-% of an additive into at least two smaller pieces,
heating the pieces at a temperature above the glass transition or melt temperature of the small molecule sugar, and
extruding to form pellets or shaping into recycled sugar-based composite material products.

17. The method of claim 16, wherein the pellets are formed into recycled sugar-based composite materials by extrusion, molding, 3D printing, casting, thermoforming, compression molding, vacuum forming, and/or heat pressing, or wherein the recycled sugar-based composite material is shaped by extrusion, molding, 3D printing, casting, thermoforming, compression molding, vacuum forming, and/or heat pressing.

18. The method of claim 16, wherein the small molecule sugar comprises isomalt, sorbitol, erythritol, mannitol, maltitol, xylitol, sucrose, ribose, xylose, galactose, mannose, sorbose, maltose, lactose, lactulose, trehalose, sucrose octaacetate, or mixtures thereof and the additive comprises wood flour, sawdust, calcium carbonate, casein, cellulose, cellulose derivatives, hemp, grass, salt, sodium chloride, wheat gluten, white flour, kaolin, starch, crushed glass, agricultural waste, chitosan, chitin, algae, algae derivatives, fabrics, fibers, plant fibers, natural carboxylic acids, pectin, or mixtures thereof, and wherein the sugar-based composite material optionally further comprises a dye, a pigment, a fragrance, a solvent, a carrier, a thickener, a solidifying agent, a clarifying agent, a plasticizer, an antioxidant, an antimicrobial, a processing aid, a decoration, or mixtures thereof.

19. The method of claim 16, wherein at least a portion of the sugar-based composite material further comprises a coating comprising cellulose acetate, shellac, a plasticizer, plastic, polymer, natural resins, waxes, oils, fats, metals, dyes, decorations, composite materials, or mixtures thereof.

20. A method of recycling a sugar-based composite comprising:
dissolving the sugar-based composite material of claim 1 in an aqueous environment to separate the sugar-based composite material from the coating, and
recovering the sugar-based composite material,
wherein the recovery of the sugar-based composite material is greater than about 50%.
